(19) United States
(12) Patent Application Publication
(10) Pub. No.: US 2013/0301857 A1
(43) Pub. Date: Nov. 14, 2013

(54) AUDIO PROCESSING APPARATUS

(71) Applicant: ONKYO CORPORATION, Osaka (JP)

(72) Inventor: Kazutoshi MURAKAMI, Osaka (JP)

(73) Assignee: ONKYO CORPORATION, Osaka (JP)

(21) Appl. No.: 13/886,395

(22) Filed: May 3, 2013

(30) Foreign Application Priority Data
May 10, 2012 (JP) 2012-108529

(51) Int. Cl. H04R 3/00

(52) U.S. Cl. CPC H04R 3/00
USPC 381/307

(57) ABSTRACT

The number of digital-analog converters is decreased in an audio processing apparatus that outputs an audio signal to not only a device disposed in a main room but also a device disposed in a sub-room. The audio processing apparatus includes a digital-analog conversion unit for outputting an extended left audio signal and an extended right audio signal in an analog format, or for outputting a sub-room left audio signal and a sub-room right audio signal in the analog format; and an input switch unit that switches between a supply of a combination of the extended left audio signal and the extended right audio signal to the digital-analog conversion unit and a supply of a combination of the sub-room left audio signal and the sub-room right audio signal to the digital-analog conversion unit.

### BACKGROUND OF THE INVENTION

1. Field of the Invention

The present invention relates to an audio processing apparatus that plays back multichannel audio data.

2. Description of the Related Art

There is used an audio processing system including an audio processing apparatus such as an AV amplifier, a content playback apparatus such as a BD (Blu-ray) player, and plural speakers (a main-room speaker and a sub-room speaker) connected to the AV amplifier. The AV amplifier, the BD player, and the main-room speaker are disposed in a main room. The sub-room speaker is disposed in a sub-room. The AV amplifier receives multichannel audio data transmitted from the BD player, and supplies an amplified audio signal to the main-room speaker and the sub-room speaker based on the received multichannel audio data. As a result, using the one AV amplifier and the one BD player, the audio signal can be played back in both the main-room speaker disposed in the main room and the sub-room speaker disposed in the sub-room.

A DA (Digital-Analog) conversion circuit is provided in the AV amplifier in order to convert the multichannel audio data (that is, the digital audio signal) transmitted from the BD player into the analog audio signal. In the case where the AV amplifier includes a DSP (Digital Signal Processing unit) in order to perform audio processing, the AV amplifier tentatively converts the input analog audio signal into the digital audio signal using the AD (Analog-Digital) conversion circuit, performs the audio processing using the DSP, and reconverts the digital audio signal into the analog audio signal using the DA conversion circuit.

In the conventional AV amplifier, in addition to the DA conversion circuit that generates the analog audio signal supplied to the main-room speaker disposed in the main room, it is necessary to provide the DA conversion circuit in order to generate the analog audio signal to be supplied to the sub-room speaker disposed in the sub-room. For example, as illustrated in FIG. 3, the multichannel audio data played back in the main room includes a left audio signal L (a left front audio signal), a right audio signal R (a right front audio signal), a central audio signal C, a low-frequency left audio signal SWL, a low-frequency right audio signal SWR, a surround left audio signal SL, a surround right audio signal SR, a surround back left audio signal SBL, a surround back right audio signal SBR, an outer left audio signal LW, an outer right audio signal RW, an upper left audio signal LH, and upper right audio signal RH (for example see Japanese Unexamined Patent Publication Nos. 2011-229113, 2010-183203, 2010-114640, and 2010-183202). Accordingly, it is necessary to provide the DA conversion circuit corresponding to the sub-room audio signal in addition to the DA conversion circuit corresponding to the audio signals of the channels. Therefore, the number of DA conversion circuits is increased, which results in problems such as a cost increase and an enlarged circuit scale.

### SUMMARY OF THE INVENTION

The present invention has been devised in order to solve the above problems, and an object thereof is to provide an audio processing apparatus in which the number of digital-analog converters can be decreased in the audio processing apparatus that outputs the audio signal to not only the device disposed in the main room but also the device disposed in the sub-room.

An audio processing apparatus according to a preferred embodiment of the present invention comprises:

a digital-analog conversion unit to which an extended left audio signal and an extended right audio signal in a digital format are input, the digital-analog conversion unit outputting the extended left audio signal and the extended right audio signal in an analog format, or a sub-room left audio signal and a sub-room right audio signal in the digital format being input to the digital-analog conversion unit, the digital-analog conversion unit outputting the sub-room left audio signal and the sub-room right audio signal in the analog format; and

an input switch unit that switches between a supply of a combination of the extended left audio signal and the extended right audio signal to the digital-analog conversion unit and a supply of a combination of the sub-room left audio signal and the sub-room right audio signal to the digital-analog conversion unit.

In an audio processing apparatus according to an aspect of the present invention, a digital-analog conversion unit that performs digital-analog conversion of an extended left audio signal and an extended right audio signal is also used as a digital-analog conversion unit that performs digital-analog conversion of a sub-room left audio signal and a sub-room right audio signal, so that the number of digital-analog conversion units can be decreased. Assuming that a digital-analog conversion unit that performs the digital-analog conversion of a certain audio signal (for example, the surround left audio signal and the surround right audio signal) in a basic 5.1 channels is also used as the digital-analog conversion unit that performs the digital-analog conversion of the sub-room left audio signal and the sub-room right audio signal, the surround left audio signal and the surround right audio signal cannot be played back when the sub-room left audio signal and the sub-room right audio signal are played back. However, in the audio processing apparatus according to the aspect of the present invention, the digital-analog conversion unit that performs the digital-analog conversion of the extended left audio signal and the extended right audio signal is also used as a digital-analog conversion unit that performs the digital-analog conversion of the sub-room left audio signal and the sub-room right audio signal. Therefore, the sub-room left audio signal and the sub-room right audio signal can be played back while the audio signals of the basic 5.1 channels are played back.

In a preferred embodiment, the audio processing apparatus further comprises:

an extended left audio output terminal;

an extended right audio output terminal;

a sub-room left audio output terminal;

a sub-room right audio output terminal; and

an output switch unit that switches between both the supply of the extended left audio signal output from the digital-analog conversion unit to the extended left audio output terminal and the supply of the extended right audio signal output from the digital-analog conversion unit to the extended right audio output terminal and both the supply of the sub-room left audio signal output from the digital-analog conversion unit to the sub-room left audio output terminal and the supply of the sub-room right audio signal output from the digital-analog conversion unit to the sub-room right audio output terminal.

In an audio processing apparatus according to another aspect of the present invention, a sub-room left audio output terminal and a sub-room right audio output terminal are provided independently of an extended left audio output terminal and an extended right audio output terminal. There is no particular limitation to the sub-room left audio output terminal and the sub-room right audio output terminal. For example, the sub-room left audio output terminal and the sub-room right audio output terminal may be a speaker terminal or a pre-out terminal. An output switch unit can supply the audio signal to the output terminal of the channel that should be played back.

In a preferred embodiment, the extended left audio signal is one of a surround back left audio signal, an outer left audio signal, an upper left audio signal, and a center left audio signal, and

the extended right audio signal is one of a surround back right audio signal, an outer right audio signal, an upper right audio signal, and a center right audio signal.

The present invention can provide the audio processing apparatus in which the number of digital-analog converters can be decreased in the audio processing apparatus that outputs the audio signal to not only the device disposed in the main room but also the device disposed in the sub-room.

An audio processing apparatus according to another preferred embodiment of the present invention comprises:

a first digital-analog conversion unit to which a first left audio signal and a first right audio signal in a digital format are input, the first digital-analog conversion unit outputting the first left audio signal and the first right audio signal in an analog format, or the first left audio signal and an extended left audio signal in the digital format being input to the first digital-analog conversion unit, the first digital-analog conversion unit outputting the first left audio signal and the extended left audio signal in the analog format;

a second digital-analog conversion unit to which a sub-room left audio signal and a sub-room right audio signal in the digital format are input, the second digital-analog conversion unit outputting the sub-room left audio signal and the sub-room right audio signal in the analog format, or the first right audio signal and an extended right audio signal in the digital format being input to the second digital-analog conversion unit, the second digital-analog conversion unit outputting the first right audio signal and the extended right audio signal in the analog format; and

an input switch unit that switches between both a supply of a combination of the first left audio signal and the first right audio signal to the first digital-analog conversion unit and a supply of a combination of the sub-room left audio signal and the sub-room right audio signal to the second digital-analog conversion unit and both a supply of a combination of the first left audio signal and the extended left audio signal to the first digital-analog conversion unit and a supply of a combination of the first right audio signal and the extended right audio signal to the second digital-analog conversion unit.

In an audio processing apparatus according to another aspect of the present invention, a digital-analog conversion unit that performs the digital-analog conversion of the sub-room left audio signal and the sub-room right audio signal is also used as a digital-analog conversion unit that performs the digital-analog conversion of the first right audio signal and the extended right audio signal (a second digital-analog conversion unit), and a digital-analog conversion unit that performs the digital-analog conversion of the first left audio signal and the first right audio signal is also used as a digital-analog conversion unit that performs the digital-analog conversion of the first left audio signal and the extended left audio signal (a first digital-analog conversion unit), so that the number of digital-analog conversion units can be decreased. Additionally, in the case where the sub-room left audio signal and the sub-room right audio signal are played back, the first digital-analog conversion unit performs the digital-analog conversion of the first left audio signal and the first right audio signal, so that the sub-room left audio signal and the sub-room right audio signal can be played back while the audio signals of the basic 5.1 channels are played back.

In a preferred embodiment, the audio processing apparatus further comprises an output switch unit that switches between the supply of the first left audio signal output from the first digital-analog conversion unit, the supply of the first right audio signal output from the first digital-analog conversion unit, the supply of the sub-room left audio signal output from the second digital-analog conversion unit, and the supply of the sub-room right audio signal output from the second digital-analog conversion unit and the supply of the first left audio signal output from the first digital-analog conversion unit, the supply of the first right audio signal output from the second digital-analog conversion unit, the supply of the extended left audio signal output from the first digital-analog conversion unit, and the supply of the extended right audio signal output from the second digital-analog conversion unit.

In a preferred embodiment, the audio processing apparatus further comprises:

a first left audio output terminal;

a first right audio output terminal;

an extended left audio output terminal;

an extended right audio output terminal;

a sub-room left audio output terminal; and

a sub-room right audio output terminal,

wherein the output switch unit switches between the supply of the first left audio signal output from the first digital-analog conversion unit to the first left audio output terminal, the supply of the first right audio signal output from the first digital-analog conversion unit to the first right audio output terminal, the supply of the sub-room left audio signal output from the second digital-analog conversion unit to the sub-room left audio output terminal, and the supply of the sub-room right audio signal output from the second digital-analog conversion unit to the sub-room right audio output terminal and the supply of the first left audio signal output from the first digital-analog conversion unit to the first left audio output terminal, the supply of the first right audio signal output from the second digital-analog conversion unit to the first right audio output terminal, the supply of the extended left audio signal output from the first digital-analog conversion unit to the extended left audio output terminal, and the supply of the extended right audio signal output from the second digital-analog conversion unit to the extended right audio output terminal.

In a preferred embodiment, the audio processing apparatus further comprises:

a first differential circuit; and

a second differential circuit,

wherein the first digital-analog conversion unit outputs the first left audio signal and an inversion signal of the first left audio signal based on the input first left audio signal,

the second digital-analog conversion unit outputs the first right audio signal and an inversion signal of the first right audio signal based on the input first right audio signal,

the first left audio signal output from the first digital-analog conversion unit is input to a positive-side input of the first differential circuit, and the inversion signal of the first left audio signal output from the first digital-analog conversion unit is input to a negative-side input of the first differential circuit, whereby the first differential circuit outputs the first left audio signal while an amplitude of the first left audio signal is doubled,

the first right audio signal output from the second digital-analog conversion unit is input to the positive-side input of the second differential circuit, and the inversion signal of the first right audio signal output from the second digital-analog conversion unit is input to the negative-side input of the second differential circuit, whereby the second differential circuit outputs the first right audio signal while an amplitude of the first right audio signal is doubled, and

the output switch unit further switches between the supply of the first left audio signal output from the first differential circuit to the first left audio output terminal and the supply of the first right audio signal output from the second differential circuit to the first right audio output terminal.

In an audio processing apparatus according to another aspect of the present invention, in the case where the sub-room left audio signal and the sub-room right audio signal are not played back, using the differential circuit, the first left audio signal and the first right audio signal can be output while amplitude values of first left audio signal and the first right audio signal are doubled.

In the preferred embodiment, the extended left audio signal is one of a surround back left audio signal, an outer left audio signal, an upper left audio signal, and a center left audio signal, and

the extended right audio signal is one of a surround back right audio signal, an outer right audio signal, an upper right audio signal, and a center right audio signal.

In the preferred embodiment, the first left audio signal is one of a left front audio signal and a surround left audio signal, and the first right audio signal is one of a right front audio signal and a surround right audio signal.

### BRIEF DESCRIPTION OF THE DRAWINGS

FIG. 1 is a view illustrating dispositions of an AV amplifier and speakers;

FIG. 2 is a block diagram illustrating an audio playback system including the AV speaker;

FIG. 3 is a view illustrating a channel of multichannel audio data;

FIG. 4 is a circuit block diagram illustrating a configuration of an audio processing unit;

FIG. 5 is a circuit block diagram illustrating an audio processing unit according to a modification;

FIG. 6 is a circuit block diagram illustrating an audio processing unit according to a modification;

FIG. 7 is a view illustrating another channel of multichannel audio data;

FIG. 8 is a circuit block diagram illustrating a modification of the audio processing unit;

FIG. 9 is a circuit block diagram illustrating an audio processing unit according to a second embodiment;

FIG. 10 is a circuit block diagram illustrating the audio processing unit of the second embodiment;

FIG. 11 is a circuit block diagram illustrating an audio processing unit according to a modification of the second embodiment;

FIG. 12 is a circuit block diagram illustrating an audio processing unit according to a modification of the second embodiment;

FIG. 13 is a circuit block diagram illustrating an audio processing unit according to a modification of the second embodiment;

FIG. 14 is a circuit block diagram illustrating an audio processing unit according to a modification of the second embodiment;

FIG. 15 is a circuit block diagram illustrating an audio processing unit according to a modification of the second embodiment;

FIG. 16 is a circuit block diagram illustrating an audio processing unit according to a modification of the second embodiment; and

FIG. 17 is a circuit block diagram illustrating an audio processing unit according to a modification of the second embodiment.

### DETAILED DESCRIPTION OF THE PREFERRED EMBODIMENTS

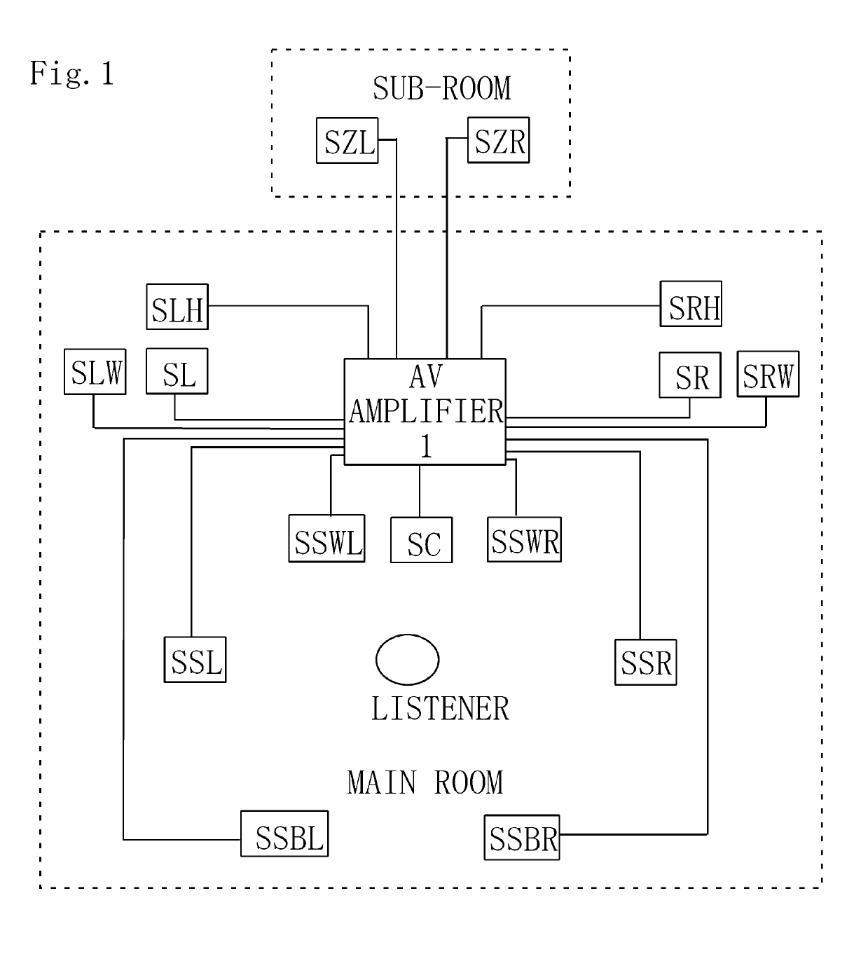

Hereinafter, an audio playback system including a content playback apparatus (hereinafter referred to as a BD player), an audio processing apparatus (hereinafter referred to as an AV amplifier), and a display apparatus according to preferred embodiments of the present invention will specifically be described with reference to the drawings. However, the present invention is not limited to the embodiments. FIG. 1 is a view illustrating an example of dispositions of an AV amplifier 1 and speakers according to a first embodiment. The BD player, the AV amplifier, the display apparatus, and the main-room speaker are disposed in a main room, and a sub-room speaker is disposed in a sub-room. From the commercial viewpoint, for example, the sub-room is called ZONE2, ZONE3, and ZONE4.

A left speaker SL, a right speaker SR, a central speaker SC, a low-frequency left speaker SSWL, a low-frequency right speaker SSWR, a surround left speaker SSL, a surround right speaker SSR, a surround back left speaker SSBL, a surround back right speaker SSBR, an upper left speaker SLH, an upper right speaker SRH, an outer left speaker SLW, and an outer right speaker SRW that are of the main-room speakers are connected to the AV amplifier 1. A sub-room left speaker SZL and a sub-room right speaker SZR that are of the sub-room speakers are connected to the AV amplifier 1.

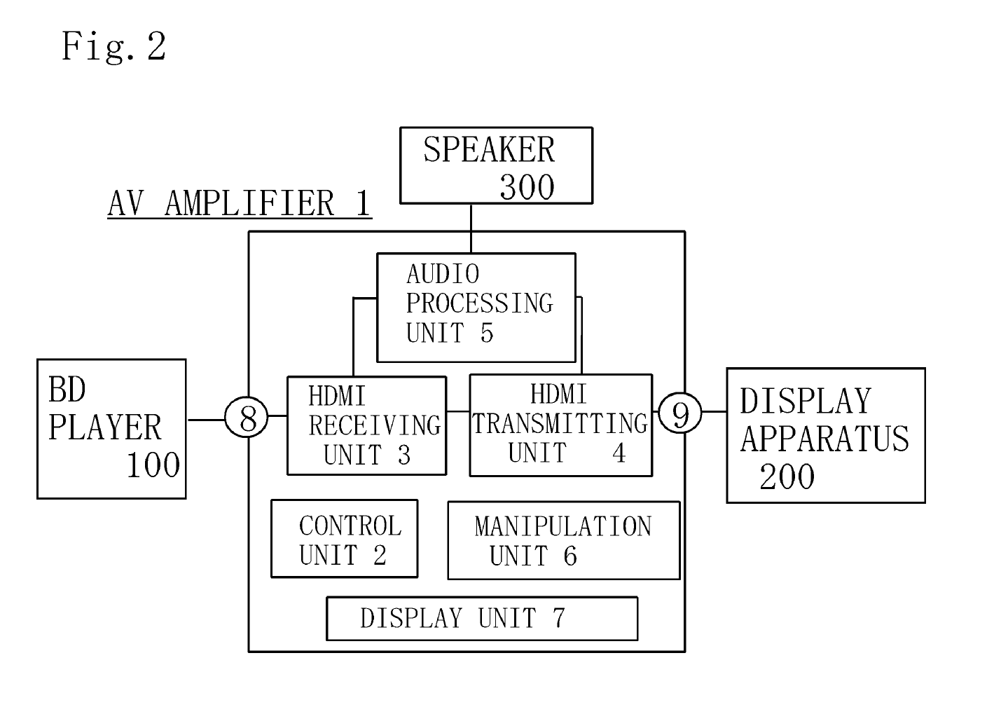

FIG. 2 is a block diagram illustrating a configuration of an audio playback system. For example, a BD player 100, the AV amplifier 1, and a display apparatus 200 are compliant with an HDMI standard, and are connected to one another through an HDMI cable. The BD player 100 transmits HDMI data including multichannel audio data and video data to the AV amplifier 1. The AV amplifier 1 amplifies the multichannel audio data, which is received from the BD player 100 and included in the HDMI data, and outputs the multichannel audio data to the speakers. The AV amplifier 1 transmits the HDMI data including the video data to the display apparatus 200. The display apparatus 200 displays the video data, which is received from the AV amplifier 1 and included in the HDMI data.

The AV amplifier 1 includes a control unit 2, an HDMI receiving unit 3, an HDMI transmitting unit 4, an audio processing unit 5, a manipulation unit 6, a display unit 7, and HDMI terminals 8 and 9. A speaker 300 (corresponding to the main-room speakers and sub-room speakers in FIG. 1) is connected to the AV amplifier 1.

The HDMI receiving unit 3 receives the HDMI data transmitted from the BD player 100, generates original video data from the received HDMI data, and supplies the original video data to the HDMI transmitting unit 4. The HDMI receiving unit 3 generates original multichannel audio data from the received HDMI data, and supplies the original multichannel audio data to the audio processing unit 5.

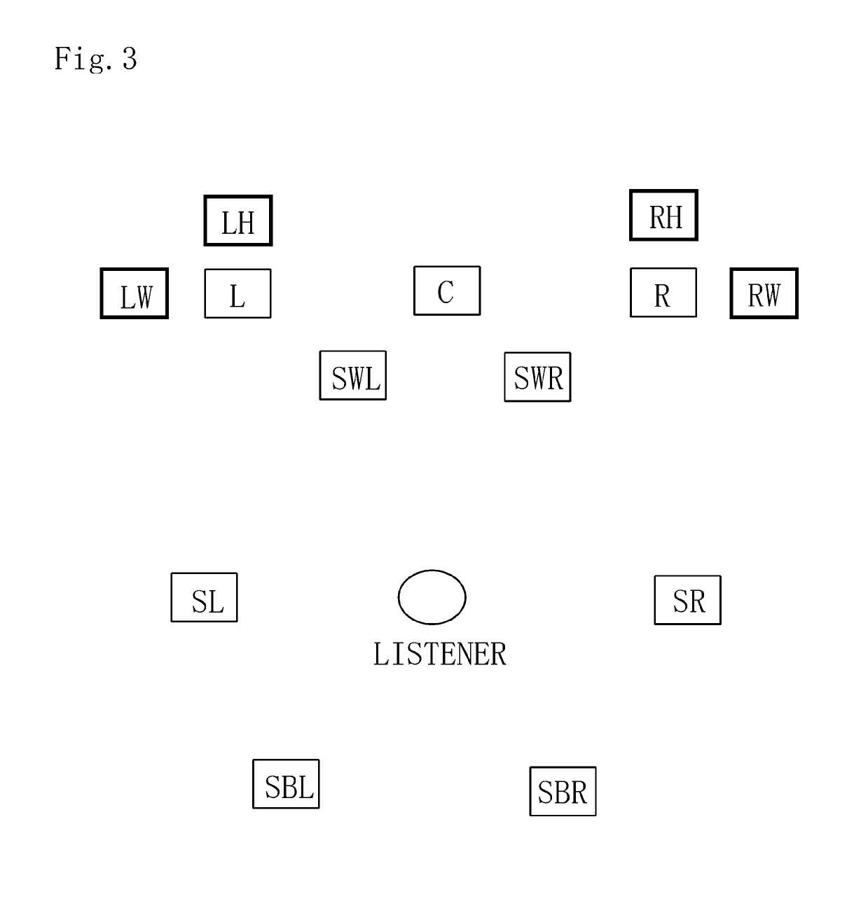

The audio processing unit 5 decodes the multichannel audio data supplied from the HDMI receiving unit 3, performs pieces of processing, such as acoustic processing, D/A conversion processing, a volume adjusting processing, and amplifying processing, and supplies an audio signal of each channel to the speaker 300. The multichannel audio data supplied to the audio processing unit 5 will be described. As illustrated in FIG. 3, HD (High Definition)-related audio formats, such as Dolby True HD, Dolby Digital Plus, and DTS-HD include a left audio signal L (left front audio signal), a right audio signal R (right front audio signal), a central audio signal C, a low-frequency left audio signal SWL, a low-frequency right audio signal SWR, a surround left audio signal SL, a surround right audio signal SR, a surround back left audio signal SBL, a surround back right audio signal SBR, an outer left audio signal LW, an outer right audio signal RW, an upper left audio signal LH, and an upper right audio signal RH.

The surround back left audio signal SBL is played back from a position on a back left side of a user. The surround back right audio signal SBR is played back from a position on a back right side of the user. The outer left audio signal LW is played back from a position (that is, on a left front outside of the user) of an outside (a left side) of the left audio signal L. The outer right audio signal RW is played back from a position (that is, on a right front outside of the user) of an outside (a right side) of the right audio signal R. The upper left audio signal LH is played back from a position (that is, on a front upper left of the user) of an upside of the left audio signal L. The upper right audio signal RH is played back from a position (that is, on a front upper right of the user) of the upside of the right audio signal R.

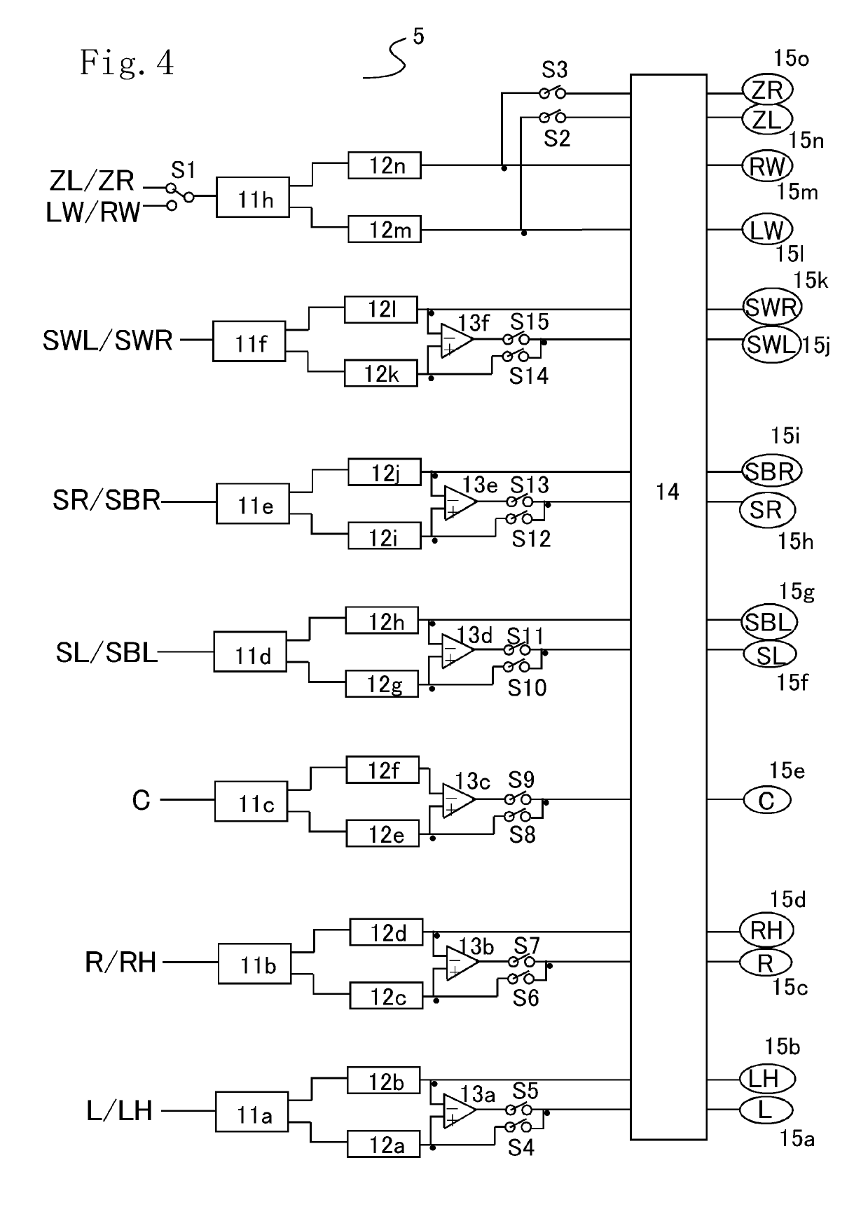

FIG. 4 is a block diagram illustrating a main part of the audio processing unit 5. The audio processing unit 5 includes a DAC (Digital-Analog Converter) 11 (11a to 11h), an LPF (Low-Pass Filter) 12 (12a to 12n), a differential circuit 13 (13a to 13f), switches S1 to S15, a volume adjuster 14 (including an amplifier circuit), and a speaker terminal 15 (15a to 15o). A DSP (Digital Signal Processing unit) and the like that are provided at a front stage of the DAC 11 are not illustrated in FIG. 4.

The DSP (not illustrated) decodes the multichannel audio data supplied from the HDMI receiving unit 3, and generates the audio data of each channel. The generated pieces of audio data of the channels are supplied to the DACs 11a to 11f and an input side of the switch S1.

Particularly, a combination L/LH of the left audio signal L and the upper left audio signal LH is supplied from the DSP to the DAC 11a. A combination R/RH of the right audio signal R and the upper right audio signal RH is supplied from the DSP to the DAC 11b. The central audio signal C is supplied from the DSP to the DAC 11c. A combination SL/SBL of the surround left audio signal SL and the surround back left audio signal SBL is supplied from the DSP to the DAC 11d. A combination SR/SBR of the surround right audio signal SR and the surround back right audio signal SBR is supplied from the DSP to the DAC 11e. A combination SWL/SWR of the low-frequency left audio signal SWL and the low-frequency right audio signal SWR is supplied from the DSP to the DAC 11f. A combination LW/RW of the outer left audio signal LW and the outer right audio signal RW is supplied from the DSP to one end (a lower terminal in the drawings) on the input side of the switch S1. A combination ZL/ZR of the sub-room left audio signal ZL and the sub-room right audio signal ZR is supplied from the HDMI receiving unit 3 to the other end (an upper terminal in the drawings) on the input side of the switch S1.

Based on each clock signal supplied from the control unit 2, the DAC 11 performs digital-analog conversion of the supplied audio signal (a digital audio signal) of each channel, and supplies the analog audio signal of each channel to the LPF 12.

Particularly, the combination L/LH of the left audio signal L and the upper left audio signal LH is supplied to the DAC 11a, and the DAC 11a supplies the analog left audio signal L to the LPF 12a and supplies the analog upper left audio signal LH to the LPF 12b (in the case where a differential output is performed, the DAC 11a supplies the analog left audio signal L to the LPF 12a and supplies an inversion signal L− of the analog left audio signal L to the LPF 12b).

The combination R/RH of the right audio signal R and the upper right audio signal RH is supplied to the DAC 11b, and the DAC 11b supplies the analog right audio signal R to the LPF 12c and supplies the analog upper right audio signal RH to the LPF 12d (in the case where the differential output is performed, the DAC 11b supplies the analog right audio signal R to the LPF 12c and supplies an inversion signal R− of the analog right audio signal R to the LPF 12d).

The central audio signal C is supplied to the DAC 11c, and the DAC 11c supplies the analog central audio signal C to the LPF 12e (in the case where the differential output is performed, the DAC 11c supplies the analog central audio signal C to the LPF 12e and supplies an inversion signal C− of the analog central audio signal C to the LPF 12f).

The combination SL/SBL of the surround left audio signal SL and the surround back left audio signal SBL is supplied to the DAC 11d, and the DAC 11d supplies the analog surround left audio signal SL to the LPF 12g and supplies the analog surround back left audio signal SBL to the LPF 12h (in the case where the differential output is performed, the DAC 11d supplies the analog surround left audio signal SL to the LPF 12g and supplies an inversion signal SL− of the analog surround left audio signal SL to the LPF 12h).

The combination SR/SBR of the surround right audio signal SR and the surround back right audio signal SBR is supplied to the DAC 11e, and the DAC 11e supplies the analog surround right audio signal SR to the LPF 12i and supplies the analog surround back right audio signal SBR to the LPF 12j (in the case where the differential output is performed, the DAC 11e supplies the analog surround right audio signal SR to the LPF 12i and supplies an inversion signal SR− of the analog surround right audio signal SR to the LPF 12j).

The combination SWL/SWR of the low-frequency left audio signal SWL and the low-frequency right audio signal SWR is supplied to the DAC 11f, and the DAC 11f supplies the analog low-frequency left audio signal SWL to the LPF 12k and supplies the analog low-frequency right audio signal SWR to the LPF 12l (in the case where the differential output is performed, the DAC 11f supplies the analog low-frequency left audio signal SWL to the LPF 12k and supplies an inversion signal SWL− of the analog low-frequency left audio signal SWL to the LPF 12l).

The switch S1 is controlled according to an instruction from the control unit 2, and switches between the supply of the combination LW/RW of the outer left audio signal LW and the outer right audio signal RW to the DAC 11h and the supply of the combination ZL/ZR of the sub-room left audio signal ZL and the sub-room right audio signal ZR to the DAC 11h.

The combination LW/RW of the outer left audio signal LW and the outer right audio signal RW is supplied from the switch S1 to the DAC 11h, and the DAC 11h supplies the analog outer left audio signal LW to the LPF 12m and supplies the analog outer right audio signal RW to the LPF 12n. In the case where the audio signal is output to the sub-room speaker, the combination ZL/ZR of the sub-room left audio signal ZL and the sub-room right audio signal ZR is supplied from the switch S1 to the DAC 11h, and the DAC 11h supplies the analog sub-room left audio signal ZL to the LPF 12m and supplies the analog sub-room right audio signal ZR to the LPF 12n.

The LPF 12 removes a high-frequency component (a high-frequency noise) from the supplied audio signal of each channel and supplies the audio signal to the differential circuit 13, the switches, and volume adjuster 14.

Particularly, the LPF 12a supplies the left audio signal L to the switch S4 and a positive-side input terminal of the differential circuit 13a. The LPF 12b supplies the upper left audio signal LH to the volume adjuster 14 and a negative-side input terminal of the differential circuit 13a (in the case where the differential output is performed, the LPF 12b supplies the inversion signal L− of the left audio signal L to the negative-side input terminal of the differential circuit 13a).

The LPF 12c supplies the right audio signal R to the switch S6 and the positive-side input terminal of the differential circuit 13b. The LPF 12d supplies the upper right audio signal RH to the volume adjuster 14 and the negative-side input terminal of the differential circuit 13b (in the case where the differential output is performed, the LPF 12d supplies the inversion signal R− of the right audio signal R to the negative-side input terminal of the differential circuit 13b).

The LPF 12e supplies the central audio signal C to the switch S8 and the positive-side input terminal of the differential circuit 13c (in the case where the differential output is performed, the LPF 12f supplies the inversion signal C− of the central audio signal C to the negative-side input terminal of the differential circuit 13c).

The LPF 12g supplies the surround left audio signal SL to the switch S10 and the positive-side input terminal of the differential circuit 13d. The LPF 12h supplies the surround back left audio signal SBL to the volume adjuster 14 and the negative-side input terminal of the differential circuit 13d (in the case where the differential output is performed, the LPF 12h supplies the inversion signal SL− of the surround left audio signal SL to the negative-side input terminal of the differential circuit 13d).

The LPF 12i supplies the surround right audio signal SR to the switch S12 and the positive-side input terminal of the differential circuit 13e. The LPF 12j supplies the surround back right audio signal SBR to the volume adjuster 14 and the negative-side input terminal of the differential circuit 13e (in the case where the differential output is performed, the LPF 12j supplies the inversion signal SR− of the surround right audio signal SR to the negative-side input terminal of the differential circuit 13e).

The LPF 12k supplies the low-frequency left audio signal SWL to the switch S14 and the positive-side input terminal of the differential circuit 13f. The LPF 12l supplies the low-frequency right audio signal SWR to the volume adjuster 14 and the negative-side input terminal of the differential circuit 13f (in the case where the differential output is performed, the LPF 12l supplies the inversion signal SWL− of the low-frequency left audio signal SWL to the negative-side input terminal of the differential circuit 13f).

The LPF 12m supplies the outer left audio signal LW to the volume adjuster 14 and the switch S2. In the case where the audio signal is output to the sub-room speaker, the LPF 12m supplies the sub-room left audio signal ZL to the volume adjuster 14 and the switch S2. The LPF 12n supplies the outer right audio signal RW to the volume adjuster 14 and the switch S3. In the case where the audio signal is output to the sub-room speaker, the LPF 12n supplies the sub-room right audio signal ZR to the volume adjuster 14 and the switch S3.

In the case where the differential output is performed, the audio signal of each channel is supplied to the positive-side input terminal of the differential circuit 13, and the inversion signal of the audio signal of each channel is supplied to the negative-side input terminal, whereby the differential circuit 13 supplies the audio signal of each channel to the switch while an amplitude value of the audio signal is doubled.

Particularly, in the case where the differential output is performed, the left audio signal L is supplied to the positive-side input terminal of the differential circuit 13a, and the inversion signal L− of the left audio signal L is supplied to the negative-side input terminal, whereby the differential circuit 13a supplies the left audio signal L to the switch S5 while the amplitude of the left audio signal L is doubled.

In the case where the differential output is performed, the right audio signal R is supplied to the positive-side input terminal of the differential circuit 13b, and the inversion signal R− of the right audio signal R is supplied to the negative-side input terminal, whereby the differential circuit 13b supplies the right audio signal R to the switch S7 while the amplitude of the right audio signal R is doubled.

In the case where the differential output is performed, the central audio signal C is supplied to the positive-side input terminal of the differential circuit 13c, and the inversion signal C− of the central audio signal C is supplied to the negative-side input terminal, whereby the differential circuit 13c supplies the central audio signal C to the switch S9 while the amplitude of the central audio signal C is doubled.

In the case where the differential output is performed, the surround left audio signal SL is supplied to the positive-side input terminal of the differential circuit 13d, and the inversion signal SL− of the surround left audio signal SL is supplied to the negative-side input terminal, whereby the differential circuit 13d supplies the surround left audio signal SL to the switch S11 while the amplitude of the surround left audio signal SL is doubled.

In the case where the differential output is performed, the surround right audio signal SR is supplied to the positive-side input terminal of the differential circuit 13e, and the inversion signal SR− of the surround right audio signal SR is supplied to the negative-side input terminal, whereby the differential circuit 13e supplies the surround right audio signal SR to the switch S13 while the amplitude of the surround right audio signal SR is doubled.

In the case where the differential output is performed, the low-frequency left audio signal SWL is supplied to the positive-side input terminal of the differential circuit 13f, and the inversion signal SWL− of the low-frequency left audio signal SWL is supplied to the negative-side input terminal, whereby the differential circuit 13f supplies the low-frequency left audio signal SWL to the switch S15 while the amplitude of the low-frequency left audio signal SWL is doubled.

On-off control is performed to the switches S2 to S15 based on the instruction from the control unit 2. The switch S2 switches the supply of the audio signal from the LPF 12m to the sub-room left speaker terminal 15n through the volume adjuster 14. That is, the switch S2 is controlled so as to be in an on state in the case where the audio signal is supplied to the sub-room speaker, namely, in the case where the outer left audio signal LW is not supplied to the outer left speaker terminal 15l, and the switch S2 is controlled so as to be in an off state in the case where the audio signal is not supplied to the sub-room speaker.

The switch S3 switches the supply of the audio signal from the LPF 12n to the sub-room right speaker terminal 15o through the volume adjuster 14. That is, the switch S3 is controlled so as to be in the on state in the case where the audio signal is supplied to the sub-room speaker, namely, in the case where the outer right audio signal RW is not supplied to the outer left speaker terminal 15m, and the switch S3 is controlled so as to be in the off state in the case where the audio signal is not supplied to the sub-room speaker.

The switch S4 switches the supply of the left audio signal L from the LPF 12a to the left speaker terminal 15a through the volume adjuster 14. The switch S5 switches the supply of the left audio signal L from the differential circuit 13a to the left speaker terminal 15a through the volume adjuster 14.

The switch S6 switches the supply of the right audio signal R from the LPF 12c to the right speaker terminal 15c through the volume adjuster 14. The switch S7 switches the supply of the right audio signal R from the differential circuit 13b to the right speaker terminal 15c through the volume adjuster 14.

The switch S8 switches the supply of the central audio signal C from the LPF 12e to the central speaker terminal 15e through the volume adjuster 14. The switch S9 switches the supply of the central audio signal C from the differential circuit 13c to the central speaker terminal 15e through the volume adjuster 14.

The switch S10 switches the supply of the surround left audio signal SL from the LPF 12g to the surround left speaker terminal 15f through the volume adjuster 14. The switch S11 switches the supply of the surround left audio signal SL from the differential circuit 13d to the surround left speaker terminal 15f through the volume adjuster 14.

The switch S12 switches the supply of the surround right audio signal SR from the LPF 12i to the surround right speaker terminal 15h through the volume adjuster 14. The switch S13 switches the supply of the surround right audio signal SR from the differential circuit 13e to the surround right speaker terminal 15h through the volume adjuster 14.

The switch S14 switches the low-frequency left audio signal SWL from the LPF 12k to the low-frequency left speaker terminal 15j through the volume adjuster 14. The switch S15 switches the low-frequency left audio signal SWL from the differential circuit 13f to the low-frequency left speaker terminal 15j through the volume adjuster 14.

The volume adjuster 14 adjusts a volume of the audio signal of each channel (and an amplifier circuit performs amplification processing as needed basis), and supplies the audio signal to the speaker terminal 15 of each channel. Particularly, the volume adjuster 14 adjusts the volume of the left audio signal L from the switch S4 or S5, and supplies the left audio signal L to the left speaker terminal 15a. The volume adjuster 14 adjusts the volume of the upper left audio signal LH from the LPF 12b, and supplies the upper left audio signal LH to the upper left speaker terminal 15b.

The volume adjuster 14 adjusts the volume of the right audio signal R from the switch S6 or S7, and supplies the right audio signal R to the right speaker terminal 15c. The volume adjuster 14 adjusts the volume of the upper right audio signal RH from the LPF 12d, and supplies the upper right audio signal RH to the upper right speaker terminal 15d. The volume adjuster 14 adjusts the volume of the central audio signal C from the switch S8 or S9, and supplies the central audio signal C to the central speaker terminal 15e. The volume adjuster 14 adjusts the volume of the surround left audio signal SL from the switch S10 or S11, and supplies the surround left audio signal SL to the surround left speaker terminal 15f. The volume adjuster 14 adjusts the volume of the surround back left audio signal SBL from the LPF 12h, and supplies the surround back left audio signal SBL to the surround back left speaker terminal 15g.

The volume adjuster 14 adjusts the volume of the surround right audio signal SR from the switch S12 or S13, and supplies the surround right audio signal SR to the surround right speaker terminal 15h. The volume adjuster 14 adjusts the volume of the surround back right audio signal SBR from the LPF 12j, and supplies the surround back right audio signal SBR to the surround back right speaker terminal 15i. The volume adjuster 14 adjusts the volume of the low-frequency left audio signal SWL from the switch S14 or S15, and supplies the low-frequency left audio signal SWL to the low-frequency left speaker terminal 15j. The volume adjuster 14 adjusts the volume of the low-frequency right audio signal SWR from the LPF 12l, and supplies the low-frequency right audio signal SWR to the low-frequency right speaker terminal 15k.

The volume adjuster 14 adjusts the volume of the outer left audio signal LW from the LPF 12m, and supplies the outer left audio signal LW to the outer left speaker terminal 15l. In the case where the audio signal is supplied to the sub-room speaker (that is, the outer left audio signal LW is not output), the volume adjuster 14 puts the audio signal from the LPF 12m into a mute state so as not to supply the audio signal to the outer left speaker terminal 15l. That is, the volume adjuster 14 also acts as a switch for the outer left audio signal LW. The volume adjuster 14 adjusts the volume of the outer right audio signal RW from the LPF 12n, and supplies the outer right audio signal RW to the outer right speaker terminal 15m.

In the case where the audio signal is supplied to the sub-room speaker (that is, the outer right audio signal RW is not output), the volume adjuster 14 puts the audio signal from the LPF 12n into the mute state so as not to supply the audio signal to the outer right speaker terminal 15m. That is, the volume adjuster 14 also acts as a switch for the outer right audio signal RW. The volume adjuster 14 adjusts the volume of the sub-room left audio signal ZL from the switch S2, and supplies the sub-room left audio signal ZL to the sub-room left speaker terminal 15n. The volume adjuster 14 adjusts the volume of the sub-room right audio signal ZR from the switch S3, and supplies the sub-room right audio signal ZR to the sub-room right speaker terminal 15o.

The left speaker SL can be connected to the left speaker terminal 15a. The upper left speaker SLH can be connected to the upper left speaker terminal 15b. The right speaker SR can be connected to the right speaker terminal 15c. The upper right speaker SRH can be connected to the upper right speaker terminal 15d. The central speaker SC can be connected to the central speaker terminal 15e.

The surround left speaker SSL can be connected to the surround left speaker terminal 15f. The surround back left speaker SSBL can be connected to the surround back left speaker terminal 15g. The surround right speaker SSR can be connected to the surround right speaker terminal 15h. The surround back right speaker SSBR can be connected to the surround back right speaker terminal 15i. The low-frequency left speaker SSWL can be connected to the low-frequency left speaker terminal 15j. The low-frequency right speaker SSWR can be connected to the low-frequency right speaker terminal 15k.

The outer left speaker SLW can be connected to the outer left speaker terminal 15l. The outer right speaker SRW can be connected to the outer right speaker terminal 15m. The sub-room left speaker SZL can be connected to the sub-room left speaker terminal 15n. The sub-room right speaker SZR can be connected to the sub-room right speaker terminal 15o. The sub-room left speaker terminal 15n may be a pre-out terminal. In this case, the sub-room left speaker terminal 15n is directly connected to the switch S2 (that is, the volume adjuster 14 is not interposed therebetween), and a speaker equipped with the volume adjuster (and the amplifier circuit) is used as the sub-room left speaker SZL. The sub-room right speaker terminal 15o may be a pre-out terminal. In this case, the sub-room right speaker terminal 15o is directly connected to the switch S3 (that is, the volume adjuster 14 is not interposed therebetween), and a speaker equipped with the volume adjuster (and the amplifier circuit) is used as the sub-room right speaker SZR.

An operation of the audio processing unit 5 of the first embodiment will be described below.

(1) In the Case where the Audio Signal is Supplied to the Sub-Room Speaker

The control unit 2 causes the switch S1 to supply the combination ZL/ZR of the sub-room left audio signal ZL and the sub-room right audio signal ZR to the DAC 11h (that is, the switch S1 is switched to the upper side), the control unit 2 controls the switches S2 and S3 such that they are in the on state, and the control unit 2 causes the volume adjuster 14 to stop the supply of the audio signal to the outer left speaker terminal 15l and the outer right speaker terminal 15m. Accordingly, the DAC 11h performs the digital-analog conversion of the input audio signal, supplies the sub-room left audio signal ZL to the LPF 12m, and supplies the sub-room right audio signal ZR to the LPF 12n. The high-frequency component of the sub-room left audio signal ZL is removed by the LPF 12m, and the sub-room left audio signal ZL is supplied to the volume adjuster 14 through the switch S2. The high-frequency component of the sub-room right audio signal ZR is removed by the LPF 12n, and the sub-room right audio signal ZR is supplied to the volume adjuster 14 through the switch S3. The volume adjuster 14 adjusts the volume of the sub-room left audio signal ZL, and supplies the sub-room left audio signal ZL to the sub-room left speaker SZL through the sub-room left speaker terminal 15n. The volume adjuster 14 adjusts the volume of the sub-room right audio signal ZR, and supplies the sub-room right audio signal ZR to the sub-room right speaker SZR through the sub-room right speaker terminal 15o. The volume adjuster 14 puts the sub-room left audio signal ZL into the mute state so as not to supply the sub-room left audio signal ZL to the outer left speaker terminal 15l, and puts the sub-room right audio signal ZR into the mute state so as not to supply the sub-room right audio signal ZR to the outer right speaker terminal 15m. At this point, the audio signals of other channels may be output from the speaker terminals of the channels, and the audio signals of basic 5.1 channels may differentially be output.

(2) In the Case where the Audio Signal is Supplied to the Outer Left Speaker and the Outer Right Speaker

The control unit 2 causes the switch S1 to supply the combination LW/RW of the outer left audio signal LW and the outer right audio signal RW to the DAC 11h (that is, the switch S1 is switched to the lower side), and controls the switches S2 and S3 such that they are in the off state. Accordingly, the DAC 11h performs the digital-analog conversion of the input audio signal, supplies the outer left audio signal LW to the LPF 12m, and supplies the outer right audio signal RW to the LPF 12n. The high-frequency component of the outer left audio signal LW is removed by the LPF 12m, and the outer left audio signal LW is supplied to the volume adjuster 14. The high-frequency component of the outer right audio signal RW is removed by the LPF 12n, and the outer right audio signal RW is supplied to the volume adjuster 14. The volume adjuster 14 adjusts the volume of the outer left audio signal LW, and supplies the outer left audio signal LW to the outer left speaker SLW through the outer left speaker terminal 15l. The volume adjuster 14 adjusts the volume of the outer right audio signal RW, and supplies the outer right audio signal RW to the outer right speaker SRW through the outer right speaker terminal 15m.

(3) In the Case where the Audio Signal is Supplied to the Speaker of Each Channel

The operation can be performed in both the cases (1) and (2). The control unit 2 controls the switches S4, S6, S8, S10, S12, and S14 such that they are in the on state, and the control unit 2 controls the switches S5, S7, S9, S11, S13, and S15 such that they are in the off state. The DAC 11a performs the digital-analog conversion of the input combination L/LH of the left audio signal L and the upper left audio signal LH, supplies the left audio signal L to the LPF 12a, and supplies the upper left audio signal LH to the LPF 12b. The high-frequency component of the left audio signal L is removed by the LPF 12a, and the left audio signal L is supplied to the volume adjuster 14 through the switch S4. The high-frequency component of the upper left audio signal LH is removed by the LPF 12b, and the upper left audio signal LH is supplied to the volume adjuster 14. The volume adjuster 14 adjusts the volume of the left audio signal L, and supplies the left audio signal L to the left speaker SL through the left speaker terminal 15a. The volume adjuster 14 adjusts the volume of the upper left audio signal LH, and supplies the upper left audio signal LH to the upper left speaker SLH through the upper left speaker terminal 15b.

The DAC 11b performs the digital-analog conversion of the input combination R/RH of the right audio signal R and the upper right audio signal RH, supplies the right audio signal R to the LPF 12c, and supplies the upper right audio signal RH to the LPF 12d. The high-frequency component of the right audio signal R is removed by the LPF 12c, and the right audio signal R is supplied to the volume adjuster 14 through the switch S6. The high-frequency component of the upper right audio signal RH is removed by the LPF 12d, and the upper right audio signal RH is supplied to the volume adjuster 14. The volume adjuster 14 adjusts the volume of the right audio signal R, and supplies the right audio signal R to the right speaker SR through the right speaker terminal 15c. The volume adjuster 14 adjusts the volume of the upper right audio signal RH, and supplies the upper right audio signal RH to the upper right speaker SRH through the upper right speaker terminal 15d.

The DAC 11c performs the digital-analog conversion of the input central audio signal C, and supplies the central audio signal C to the LPF 12e. The high-frequency component of the central audio signal C is removed by the LPF 12e, and the central audio signal C is supplied to the volume adjuster 14 through the switch S8. The volume adjuster 14 adjusts the volume of the central audio signal C, and supplies the central audio signal C to the central speaker SC through the central speaker terminal 15e.

The DAC 11d performs the digital-analog conversion of the input combination SL/SBL of the surround left audio signal SL and the surround back left audio signal SBL, supplies the surround left audio signal SL to the LPF 12g, and supplies the surround back left audio signal SBL to the LPF 12h. The high-frequency component of the surround left audio signal SL is removed by the LPF 12g, and the surround left audio signal SL is supplied to the volume adjuster 14 through the switch S10. The high-frequency component of the surround back left audio signal SBL is removed by the LPF 12h, and the surround back left audio signal SBL is supplied to the volume adjuster 14. The volume adjuster 14 adjusts the volume of the surround left audio signal SL, and supplies the surround left audio signal SL to the surround left speaker SSL through the surround left speaker terminal 15f. The volume adjuster 14 adjusts the volume of the surround back left audio signal SBL, and supplies the surround back left audio signal SBL to the surround back left speaker SSBL through the surround back left speaker terminal 15g.

The DAC 11e performs the digital-analog conversion of the input combination SR/SBR of the surround right audio signal SR and the surround back right audio signal SBR, supplies the surround right audio signal SR to the LPF 12i, and supplies the surround back right audio signal SBR to the LPF 12j. The high-frequency component of the surround right audio signal SR is removed by the LPF 12i, and the surround right audio signal SR is supplied to the volume adjuster 14 through the switch S12. The high-frequency component of the surround back right audio signal SBR is removed by the LPF 12j, and the surround back right audio signal SBR is supplied to the volume adjuster 14. The volume adjuster 14 adjusts the volume of the surround right audio signal SR, and supplies the surround right audio signal SR to the surround right speaker SSR through the surround right speaker terminal 15h. The volume adjuster 14 adjusts the volume of the surround back right audio signal SBR, and supplies the surround back right audio signal SBR to the surround back right speaker SSBR through the surround back right speaker terminal 15i.

The DAC 11f performs the digital-analog conversion of the input combination SWL/SWR of the low-frequency left audio signal SWL and the low-frequency right audio signal SWR, supplies the low-frequency left audio signal SWL to the LPF 12k, and supplies the low-frequency right audio signal SWR to the LPF 12l. The high-frequency component of the low-frequency left audio signal SWL is removed by the LPF 12k, and the low-frequency left audio signal SWL is supplied to the volume adjuster 14 through the switch S14. The high-frequency component of the low-frequency right audio signal SWR is removed by the LPF 12l, and the low-frequency right audio signal SWR is supplied to the volume adjuster 14. The volume adjuster 14 adjusts the volume of the low-frequency left audio signal SWL, and supplies the low-frequency left audio signal SWL to the low-frequency left speaker SSWL through the low-frequency left speaker terminal 15j. The volume adjuster 14 adjusts the volume of the low-frequency right audio signal SWR, and supplies the low-frequency right audio signal SWR to the low-frequency right speaker SSWR through the low-frequency right speaker terminal 15k.

(4) In the Case where the Differential Output is Performed

The operation can be performed instead of the operation (3) in both the cases (1) and (2). The control unit 2 controls the switches S5, S7, S9, S11, S13, and S15 such that they are in the on state, the control unit 2 controls the switches S4, S6, S8, S10, S12, and S14 such that they are in the off state, and the control unit 2 controls the volume adjuster 14 such that the volume adjuster 14 puts the outputs to the upper left speaker terminal 15b, upper right speaker terminal 15d, surround back left speaker terminal 15g, surround back right speaker terminal 15i, and low-frequency right speaker terminal 15k into the mute state.

The DAC 11a performs the digital-analog conversion of the input combination L/LH of the left audio signal L and the upper left audio signal LH, supplies the left audio signal L to the LPF 12a, and supplies the inversion signal L− of the left audio signal L to the LPF 12b. The high-frequency component of the left audio signal L is removed by the LPF 12a, and the left audio signal L is supplied to the positive-side input terminal of the differential circuit 13a. The high-frequency component of the inversion signal L− of the left audio signal L is removed by the LPF 12b, and the inversion signal L− of the left audio signal L is supplied to the negative-side input terminal of the differential circuit 13a. The differential circuit 13a doubles the amplitude value of the left audio signal L, and supplies the doubled left audio signal L to the volume adjuster 14 through the switch S5. The volume adjuster 14 adjusts the volume of the left audio signal L, and supplies the left audio signal L to the left speaker SL through the left speaker terminal 15a. Because the volume adjuster 14 puts the audio signal output to the upper left speaker terminal 15b into the mute state, the audio signal is not output from the upper left speaker terminal 15b.

The DAC 11b performs the digital-analog conversion of the input combination R/RH of the right audio signal R and the upper right audio signal RH, supplies the right audio signal R to the LPF 12c, and supplies the inversion signal R− of the right audio signal R to the LPF 12d. The high-frequency component of the right audio signal R is removed by the LPF 12c, and the right audio signal R is supplied to the positive-side input terminal of the differential circuit 13b. The high-frequency component of the inversion signal R− of the right audio signal R is removed by the LPF 12d, and the inversion signal R− of the right audio signal R is supplied to the negative-side input terminal of the differential circuit 13b. The differential circuit 13b doubles the amplitude value of the right audio signal R, and supplies the doubled right audio signal R to the volume adjuster 14 through the switch S7. The volume adjuster 14 adjusts the volume of the right audio signal R, and supplies the right audio signal R to the right speaker SR through the right speaker terminal 15c. Because the volume adjuster 14 puts the audio signal output to the upper right speaker terminal 15d into the mute state, the audio signal is not output from the upper right speaker terminal 15d.

The DAC 11c performs the digital-analog conversion of the input central audio signal C, supplies the central audio signal C to the LPF 12e, and supplies the inversion signal C− of the central audio signal C to the LPF 12f. The high-frequency component of the central audio signal C is removed by the LPF 12e, and the central audio signal C is supplied to the positive-side input terminal of the differential circuit 13c. The high-frequency component of the inversion signal C− of the central audio signal C is removed by the LPF 12f, and the inversion signal C− of the central audio signal C is supplied to the negative-side input terminal of the differential circuit 13c. The differential circuit 13c doubles the amplitude value of the central audio signal C, and supplies the doubled central audio signal C to the volume adjuster 14 through the switch S9. The volume adjuster 14 adjusts the volume of the central audio signal C, and supplies the central audio signal C to the central speaker SC through the central speaker terminal 15e.

The DAC 11d performs the digital-analog conversion of the input combination SL/SBL of the surround left audio signal SL and the surround back left audio signal SBL, supplies the surround left audio signal SL to the LPF 12g, and supplies the inversion signal SL− of the surround left audio signal SL to the LPF 12h. The high-frequency component of the surround left audio signal SL is removed by the LPF 12g, and the surround left audio signal SL is supplied to the positive-side input terminal of the differential circuit 13d. The high-frequency component of the inversion signal SL− of the surround left audio signal SL is removed by the LPF 12h, and the inversion signal SL− of the surround left audio signal SL is supplied to the negative-side input terminal of the differential circuit 13d. The differential circuit 13d doubles the amplitude value of the surround left audio signal SL, and supplies the doubled surround left audio signal SL to the volume adjuster 14 through the switch S11. The volume adjuster 14 adjusts the volume of the surround left audio signal SL, and supplies the surround left audio signal SL to the surround left speaker SSL through the surround left speaker terminal 15f. Because the volume adjuster 14 puts the audio signal output to the surround back left speaker terminal 15g into the mute state, the audio signal is not output from the surround back left speaker terminal 15g.

The DAC 11e performs the digital-analog conversion of the input combination SR/SBR of the surround right audio signal SR and the surround back right audio signal SBR, supplies the surround right audio signal SR to the LPF 12i, and supplies the inversion signal SR− of the surround right audio signal SR to the LPF 12j. The high-frequency component of the surround right audio signal SR is removed by the LPF 12i, and the surround right audio signal SR is supplied to the positive-side input terminal of the differential circuit 13e. The high-frequency component of the inversion signal SR− of the surround right audio signal SR is removed by the LPF 12j, and the inversion signal SR− of the surround right audio signal SR is supplied to the negative-side input terminal of the differential circuit 13e. The differential circuit 13e doubles the amplitude value of the surround right audio signal SR, and supplies the doubled surround right audio signal SR to the volume adjuster 14 through the switch S13. The volume adjuster 14 adjusts the volume of the surround right audio signal SR, and supplies the surround right audio signal SR to the surround right speaker SSR through the surround right speaker terminal 15h. Because the volume adjuster 14 puts the audio signal output to the surround back right speaker terminal 15i into the mute state, the audio signal is not output from the surround back right speaker terminal 15i.

The DAC 11f performs the digital-analog conversion of the input combination SWL/SWR of the low-frequency left audio signal SWL and the low-frequency right audio signal SWR, supplies the low-frequency left audio signal SWL to the LPF 12k, and supplies the inversion signal SWL− of the low-frequency left audio signal SWL to the LPF 12l. The high-frequency component of the low-frequency left audio signal SWL is removed by the LPF 12k, and the low-frequency left audio signal SWL is supplied to the positive-side input terminal of the differential circuit 13f. The high-frequency component of the inversion signal SWL− of the low-frequency left audio signal SWL is removed by the LPF 12l, and the inversion signal SWL− of the low-frequency left audio signal SWL is supplied to the negative-side input terminal of the differential circuit 13f. The differential circuit 13f doubles the amplitude value of the low-frequency left audio signal SWL, and supplies the doubled low-frequency left audio signal SWL to the volume adjuster 14 through the switch S15. The volume adjuster 14 adjusts the volume of the low-frequency left audio signal SWL, and supplies the low-frequency left audio signal SWL to the low-frequency left speaker SSWL through the low-frequency left speaker terminal 15j. Because the volume adjuster 14 puts the audio signal output to the low-frequency right speaker terminal 15k into the mute state, the audio signal is not output from the low-frequency right speaker terminal 15k.

As described above, in the first embodiment, the DAC that performs the digital-analog conversion of the combination ZL/ZR of the sub-room left audio signal ZL and the sub-room right audio signal ZR is also used as the DAC that performs the digital-analog conversion of the combination LW/RW of the outer left audio signal LW and the outer right audio signal RW. It is not necessary to provide the dedicated DAC that performs the digital-analog conversion of the combination ZL/ZR of the sub-room left audio signal ZL and the sub-room right audio signal ZR. Therefore, the number of DACs can be decreased. The DAC that performs the digital-analog conversion of the combination ZL/ZR of the sub-room left audio signal ZL and the sub-room right audio signal ZR is also used as the DAC that performs the digital-analog conversion of the combination LW/RW of the outer left audio signal LW and the outer right audio signal RW, whereby the audio signals can also be played back from the sub-room speakers disposed in the sub-room while the audio signals (the left audio signal L, the right audio signal R, the central audio signal C, the surround left audio signal SL, the surround right audio signal SR, and the low-frequency left audio signal SWL) of at least the basic 5.1 channels are played back from the main-room speakers disposed in the main room.

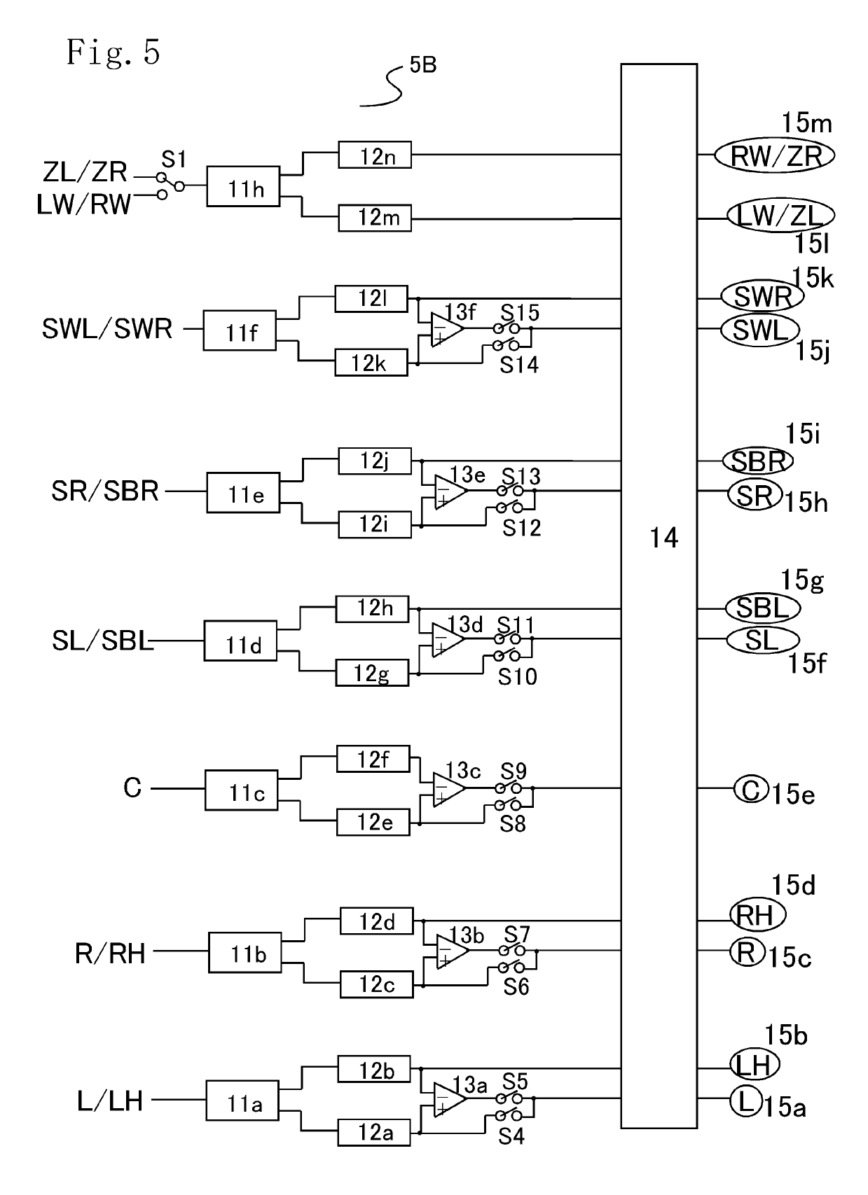

As illustrated in FIG. 5, the outer left speaker terminal 15l may also be used as the sub-room left speaker terminal, and the outer right speaker terminal 15m may also be used as the sub-room right speaker terminal. In this case, one of the outer left speaker SLW and the sub-room left speaker SZL can be connected to the outer left speaker terminal 15l. Similarly one of the outer right speaker SRW and the sub-room right speaker SZR can be connected to the outer right speaker terminal 15m. Compared with FIG. 4, the switches S2 and S3, the sub-room left speaker terminal 15n, and the sub-room right speaker terminal 15o are eliminated in FIG. 5.

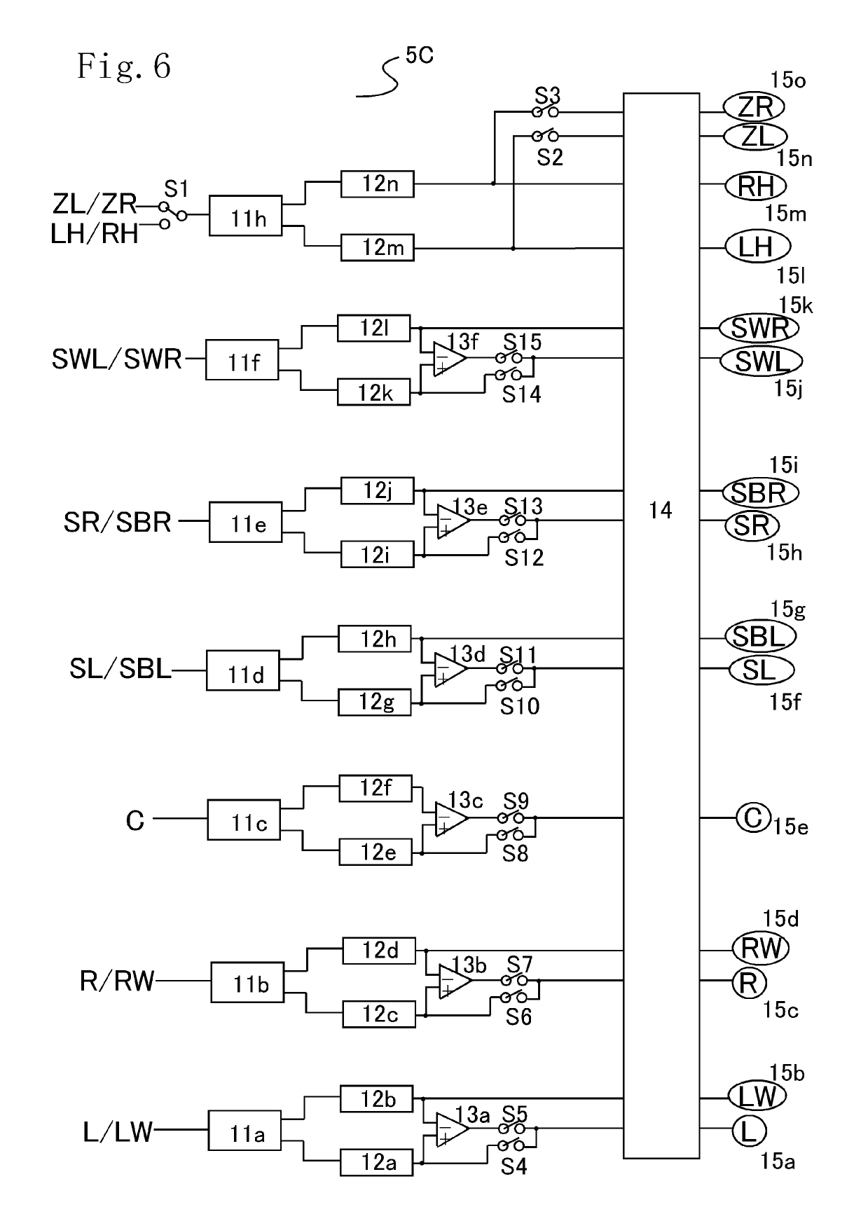

A configuration, in which the outer left audio signal LW and the upper left audio signal LH are replaced with each other while the outer right audio signal RW and the upper right audio signal RH are replaced with each other, may be used as illustrated in FIG. 6. In this case, the DAC that performs the digital-analog conversion of the combination ZL/ZR of the sub-room left audio signal ZL and the sub-room right audio signal ZR is also used as the DAC that performs the digital-analog conversion of the combination LH/RH of the upper left audio signal LH and the upper right audio signal RH.

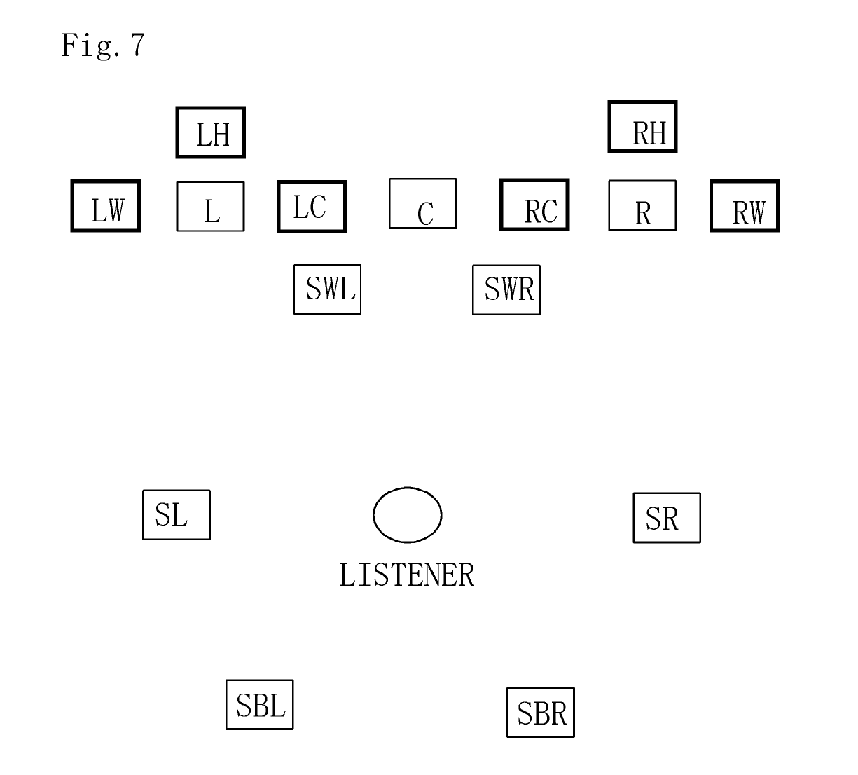

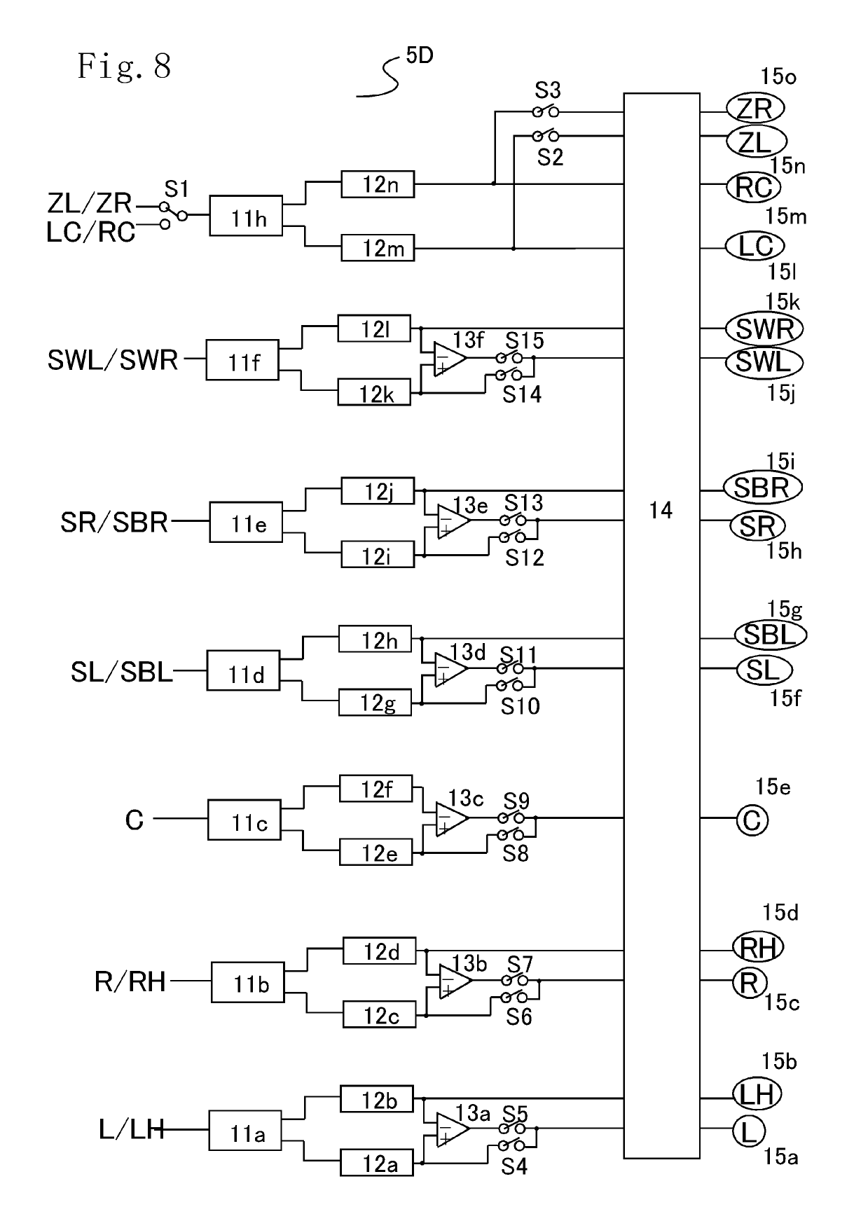

As illustrated in FIG. 7, depending on the standard of the multichannel audio data, sometimes a center left audio signal LC exists instead of (or in addition to) the outer left audio signal LW while a center right audio signal RC exists instead of (or in addition to) the outer right audio signal RW. The center left audio signal LC is played back from a position between the left audio signal L and the central audio signal C. The center right audio signal RC is played back from a position between the right audio signal R and the central audio signal C. In this case, a configuration, in which the outer left audio signal LW is replaced with the center left audio signal LC while the outer right audio signal RW is replaced with the center right audio signal RC, may be used as illustrated in FIG. 8.

In view of the foregoing, when the channels of the first embodiment are generally expressed, the outer left audio signal LW is defined as an extended left audio signal and the outer right audio signal RW is defined as an extended right audio signal in FIG. 4. The extended left audio signal may be any one of the outer left audio signal LW, the surround back left audio signal SBL, the upper left audio signal LH, and the center left audio signal LC. Similarly the extended right audio signal may be any one of the outer right audio signal RW, the surround back right audio signal SBR, the upper right audio signal RH, and the center right audio signal RC.

The DSP may selectively supply the combination LW/RW of the outer left audio signal LW and the outer right audio signal or the combination ZL/ZR of the sub-room left audio signal ZL and the sub-room right audio signal ZR to the DAC 11h without providing the switch S1. Therefore, generally the input switch unit may be either the switch S1 or the DSP.

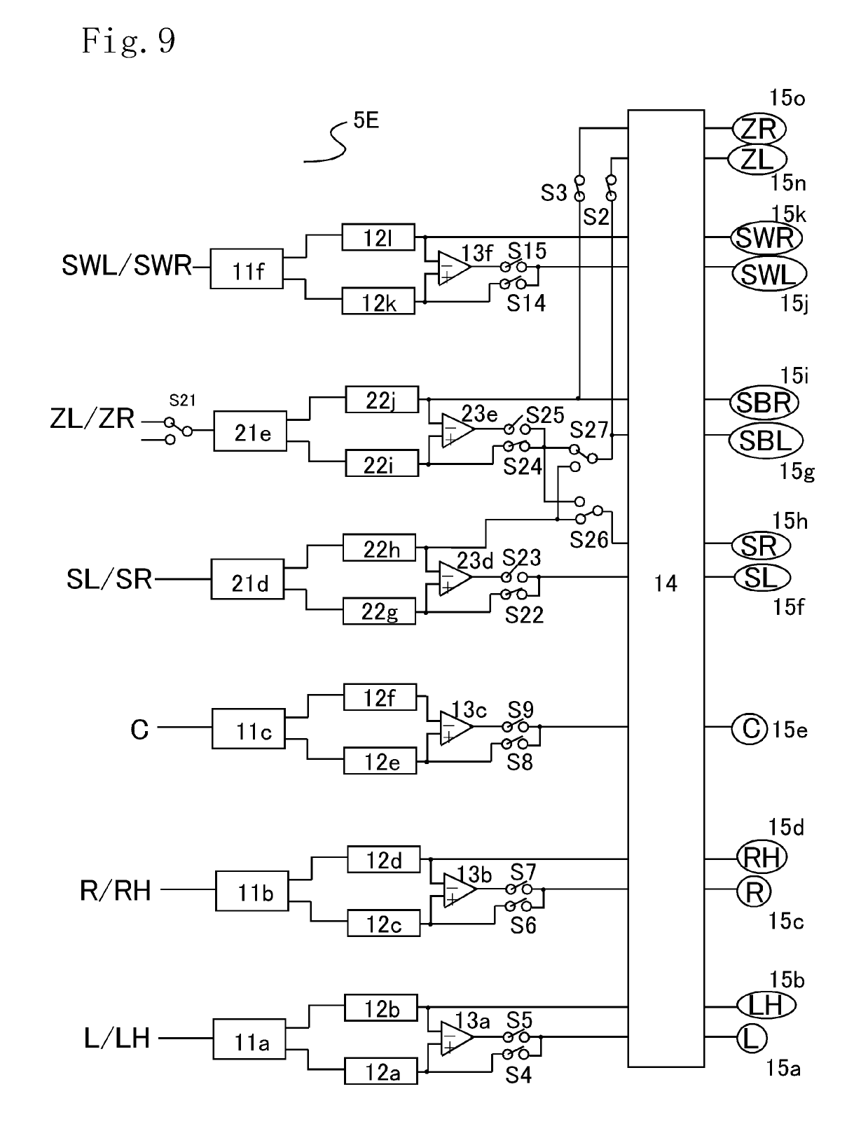

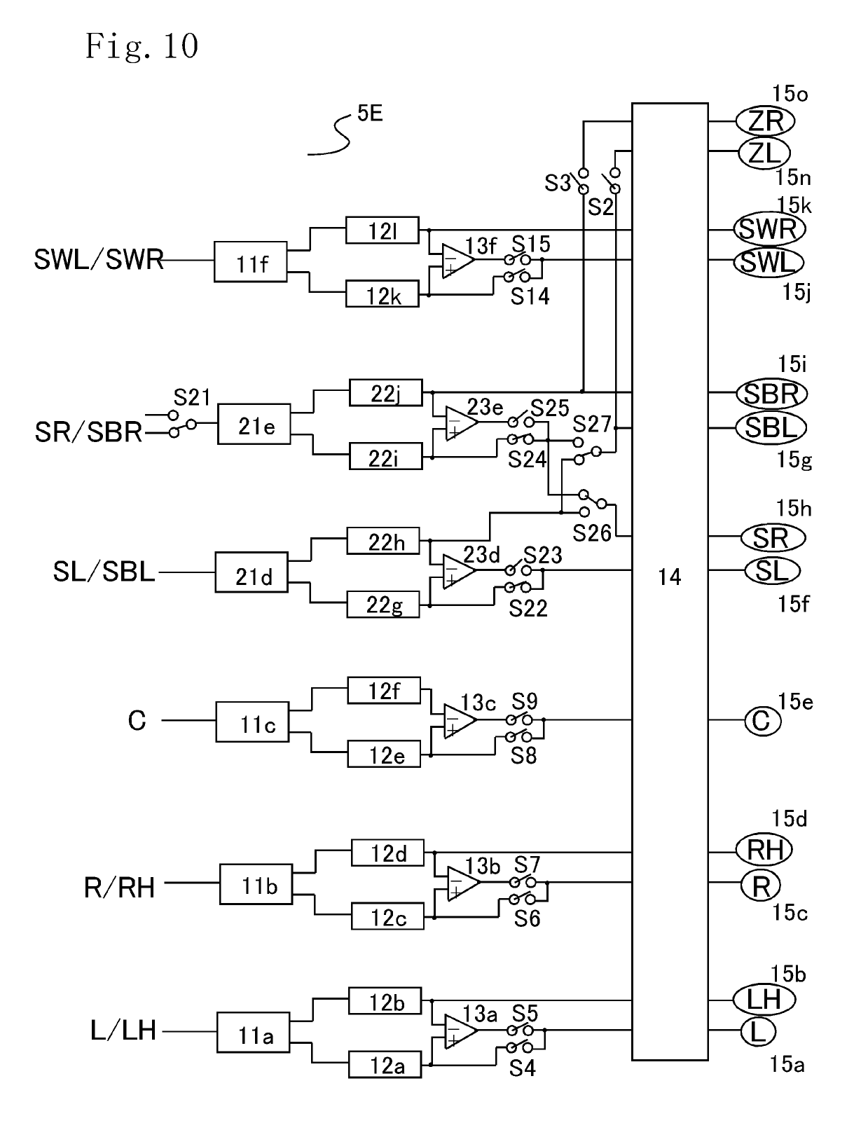

A second embodiment of the present invention will be described below. FIGS. 9 and 10 are views illustrating a configuration of audio processing unit 5E according to a second embodiment. In FIGS. 9 and 10, the same components as that in FIG. 4 are designated by the same numerals, and the overlapping description is omitted. FIG. 9 illustrates the case where the audio signal is supplied to the sub-room speaker, and FIG. 10 illustrates the case where the surround back left audio signal SBL and the surround back right audio signal are played back.

The audio processing unit 5E includes a DAC (Digital-Analog Converter) (11a, 11b, 11c, 21d, 21e, and 11f), an LPF (Low-Pass Filter) (12a to 12f, 22g to 22j, 12k, and 12l), a differential circuit (13a to 13c, 23d, 23e, and 13f), a switches S2 to S9, S14, S15, and S21 to S27, a volume adjuster 14 (including amplifier circuit), and a speaker terminal 15 (15a to 15o).

As illustrated in FIG. 9, in the case where the audio signal is supplied to the sub-room speaker, the combination SL/SR of the surround left audio signal SL and the surround right audio signal SR is supplied from the DSP to the DAC 21d. Alternatively, as illustrated in FIG. 10, in the case where the surround back left audio signal SBL and the surround back right audio signal SBR are played back, the combination SL/SBL of the surround left audio signal SL and the surround back left audio signal SBL is supplied from the DSP to the DAC 21d.

As illustrated in FIG. 9, in the case where the audio signal is supplied to the sub-room speaker, the combination ZL/ZR of the sub-room left audio signal ZL and the sub-room right audio signal ZR is supplied to one end of the input side of the switch S21, and the switch S21 supplies the combination ZL/ZR of the sub-room left audio signal ZL and the sub-room right audio signal ZR to the DAC 21e. As illustrated in FIG. 10, in the case where the surround back left audio signal SBL and the surround back right audio signal SBR are played back, the combination SR/SBR of the surround right audio signal SR and the surround back right audio signal SBR is supplied to the other end of the input side of the switch S21, and the switch S21 supplies the combination SR/SBR of the surround right audio signal SR and the surround back right audio signal SBR to the DAC 21e.

As illustrated in FIG. 9, in the case where the audio signal is supplied to the sub-room speaker, the combination SL/SR of the surround left audio signal SL and the surround right audio signal SR is supplied to the DAC 21d, and the DAC 21d supplies the analog surround left audio signal SL to the LPF 22g and supplies the analog surround right audio signal SR to the LPF 22h. As illustrated in FIG. 10, in the case where the surround back left audio signal SBL and the surround back right audio signal SBR are played back, the combination SL/SBL of the surround left audio signal SL and the surround back left audio signal SBL is supplied to the DAC 21d, and the DAC 21d supplies the analog surround left audio signal SL to the LPF 22g and supplies the analog surround back left audio signal SBL to the LPF 22h. Alternatively, as illustrated in FIG. 10, in the case where the differential output of the surround left audio signal SL is performed, the combination SL/SBL of the surround left audio signal SL and the surround back left audio signal SBL is supplied to the DAC 21d, and the DAC 21d supplies the analog surround left audio signal SL to the LPF 22g and supplies the inversion signal SL− of the analog surround left audio signal SL to the LPF 22h.

As illustrated in FIG. 9, in the case where the audio signal is output to the sub-room speaker, the combination ZL/ZR of the sub-room left audio signal ZL and the sub-room right audio signal ZR is supplied to the DAC 21e, and the DAC 21e supplies the analog sub-room left audio signal ZL to the LPF 22i and supplies the analog sub-room right audio signal ZR to the LPF 22j. As illustrated in FIG. 10, in the case where the surround back left audio signal SBL and the surround back right audio signal SBR are played back, the combination SR/SBR of the surround right audio signal SR and the surround back right audio signal SBR is supplied to the DAC 21e, and the DAC 21e supplies the analog surround right audio signal SR to the LPF 22i and supplies the analog surround back right audio signal SBR to the LPF 22j. Alternatively, as illustrated in FIG. 10, in the case where the differential output of the surround right audio signal SR is performed, the combination SR/SBR of the surround right audio signal SR and the surround back right audio signal SBR is supplied to the DAC 21e, and the DAC 21e supplies the analog surround right audio signal SR to the LPF 22i and supplies the inversion signal SR− of the analog surround right audio signal SR to the LPF 22j.

As illustrated in FIG. 9, in the case where the audio signal is supplied to the sub-room speaker, the LPF 22g supplies the surround left audio signal SL to the switch S22 and the positive-side input terminal of the differential circuit 23d. As illustrated in FIG. 10, in the case where the surround back left audio signal SBL and the surround back right audio signal SBR are played back, the LPF 22g supplies the surround left audio signal SL to the switch S22 and the positive-side input terminal of the differential circuit 23d.

As illustrated in FIG. 9, in the case where the audio signal is supplied to the sub-room speaker, the LPF 22h supplies the surround right audio signal SR to the switches S26 and S27 and the negative-side input terminal of the differential circuit 23d. As illustrated in FIG. 10, in the case where the surround back left audio signal SBL and the surround back right audio signal SBR are played back, the LPF 22h supplies the surround back left audio signal SBL to the switches S26 and S27 and the negative-side input terminal of the differential circuit 23d. Alternatively, as illustrated in FIG. 10, in the case where the differential output of the surround left audio signal SL is performed, the LPF 22h supplies the inversion signal SL− of the surround left audio signal SL to the switches S26 and S27 and the negative-side input terminal of the differential circuit 23d.

As illustrated in FIG. 9, in the case where the audio signal is supplied to the sub-room speaker, the LPF 22i supplies the sub-room left audio signal ZL to the switch S24 and the positive-side input terminal of the differential circuit 23e. As illustrated in FIG. 10, in the case where the surround back left audio signal SBL and the surround back right audio signal SBR are played back (alternatively, in the case where the differential output of the surround right audio signal SR is performed), the LPF 22i supplies the surround right audio signal SR to the switch S24 and the positive-side input terminal of the differential circuit 23e.

As illustrated in FIG. 9, in the case where the audio signal is supplied to the sub-room speaker, the LPF 22j supplies the sub-room right audio signal ZR to the switch S3 and the volume adjuster 14. As illustrated in FIG. 10, in the case where the surround back left audio signal SBL and the surround back right audio signal SBR are played back, the LPF 22j supplies the surround back right audio signal SBR to the switch S3 and the volume adjuster 14. Alternatively, as illustrated in FIG. 10, in the case where the differential output of the surround right audio signal SR is performed, the LPF 22j supplies the inversion signal SR− of the surround right audio signal SR to the negative-side input terminal of the differential circuit 23e.

As illustrated in FIG. 10, in the case where the differential output is performed, the surround left audio signal SL is supplied to the positive-side input terminal of the differential circuit 23d, and the inversion signal SL− of the surround left audio signal SL is supplied to the negative-side input terminal, whereby the differential circuit 23d supplies the surround left audio signal SL to the switch S23 while the amplitude of the surround left audio signal SL is doubled. In the case where the differential output is performed, the surround right audio signal SR is supplied to the positive-side input terminal of the differential circuit 23e, and the inversion signal SR− of the surround right audio signal SR is supplied to the negative-side input terminal, whereby the differential circuit 23e supplies the surround right audio signal SR to the switch S25 while the amplitude of the surround right audio signal SR is doubled.

The switch S22 switches the supply of the audio signal from the LPF 22g to the surround left speaker terminal 15f through the volume adjuster 14. The switch S23 switches the supply of the audio signal from the differential circuit 23d to the surround left speaker terminal 15f through the volume adjuster 14. The switch S27 switches the supply of the audio signal from the LPF 22i to one end of the input side of the switch S24. The switch S25 switches the supply of the audio signal from the differential circuit 23e to one end of the input side of the switch S26. The switch S26 switches between the supply of the audio signal from the LPF 22h to the surround right speaker terminal 15h through the volume adjuster 14 and the supply of the audio signal from the switch S25 to the surround right speaker terminal 15h through the volume adjuster 14. The switch S27 switches between the supply of the audio signal from the switch S24 to the surround back left speaker terminal and the switch S2 through the volume adjuster 14 and the supply of the audio signal from the LPF 22h to the surround back left speaker terminal and the switch S2 through the volume adjuster 14.

An operation of the audio processing unit 5E of the second embodiment will be described below.

(1) In the Case where the Audio Signal is Supplied to the Sub-Room Speaker

The description is made with reference to FIG. 9. The control unit 2 causes the DSP to supply the combination ZL/ZR of the sub-room left audio signal ZL and the sub-room right audio signal to one end (the upper side) of the switch S21. The control unit 2 causes the switch S21 to supply the combination ZL/ZR of the sub-room left audio signal ZL and the sub-room right audio signal to the DAC 21e (that is, the switch S21 is switched to the upper side), the control unit 2 controls the switches S2, S3, S22, and S24 such that they are in the on state, and the control unit 2 controls the switches S23 and S25 such that they are in the off state. The control unit 2 switches the switch S26 to the lower side (the side of the LPF 22h), switches the switch S27 to the upper side (the side of the switch S24), and causes the volume adjuster 14 to stop the supply of the audio signal to the surround back left speaker terminal 15g and the surround back right speaker terminal 15i.

The DAC 21e performs the digital-analog conversion of the input combination ZL/ZR of the sub-room left audio signal ZL and the sub-room right audio signal ZR, supplies the sub-room left audio signal ZL to the LPF 22i and supplies the sub-room right audio signal ZR to the LPF 22j. The high-frequency component of the sub-room left audio signal ZL is removed by the LPF 22i, and the sub-room left audio signal ZL is supplied to the volume adjuster 14 through the switches S24, S27, and S2. The high-frequency component of the sub-room right audio signal ZR is removed by the LPF 22j, and the sub-room right audio signal ZR is supplied to the volume adjuster 14 through the switch S3. The volume adjuster 14 adjusts the volume of the sub-room left audio signal ZL, and supplies the sub-room left audio signal ZL to the sub-room left speaker SZL through the sub-room left speaker terminal 15n. The volume adjuster 14 adjusts the volume of the sub-room right audio signal ZR, and supplies the sub-room right audio signal ZR to the sub-room right speaker SZR through the sub-room right speaker terminal 15o. The volume adjuster 14 puts the sub-room left audio signal ZL into the mute state so as not to supply the sub-room left audio signal ZL to the surround back left speaker terminal 15g, and puts the sub-room right audio signal ZR into the mute state so as not to supply the sub-room right audio signal ZR to the surround back right speaker terminal 15i.

The DAC 21d performs the digital-analog conversion of the input combination SL/SR of the surround left audio signal SL and the surround right audio signal SR, supplies the surround left audio signal SL to the LPF 22g, and supplies the surround right audio signal SR to the LPF 22h. The high-frequency component of the surround left audio signal SL is removed by the LPF 22g, and the surround left audio signal SL is supplied to the volume adjuster 14 through the switch S22. The high-frequency component of the surround right audio signal SR is removed by the LPF 22h, and the surround right audio signal SR is supplied to the volume adjuster 14 through the switch S26. The volume adjuster 14 adjusts the volume of the surround left audio signal SL, and supplies the surround left audio signal SL to the surround left speaker SSL through the surround left speaker terminal 15f. The volume adjuster 14 adjusts the volume of the surround right audio signal SR, and supplies the surround right audio signal SR to the surround right speaker SSR through the surround right speaker terminal 15h.

At this point, similarly to the first embodiment in FIG. 4, the audio signals of other channels may be output from the speaker terminals of the channels, and the audio signal of the specific channel may differentially be output.

(2) In the Case where the Surround Back Left Audio Signal SBL and the Surround Back Right Audio Signal SBR are Played Back

The description is made with reference to FIG. 10. The control unit 2 causes the DSP to supply the combination SR/SBR of the surround right audio signal SR and the surround back right audio signal SBR to the other end (the lower side) of the switch S21. The control unit 2 causes the switch S21 to supply the combination SR/SBR of the surround right audio signal SR and the surround back right audio signal SBR to the DAC 21e (that is, the switch S21 is switched to the lower side), the control unit 2 controls the switches S22 and S24 such that they are in the on state, and the control unit 2 controls the switches S2, S3, S23, and S25 such that they are in the off state. The control unit 2 switches the switch S26 to the upper side (the side of the switch S24), and switches the switch S27 to the lower side (the side of the LPF 22h).

The DAC 21d performs the digital-analog conversion of the input combination SL/SBL of the surround left audio signal SL and the surround back left audio signal SBL, which are input from the DSP, supplies the surround left audio signal SL to the LPF 22g, and supplies the surround back left audio signal SBL to the LPF 22h. The high-frequency component of the surround left audio signal SL is removed by the LPF 22g, and the surround left audio signal SL is supplied to the volume adjuster 14 through the switch S22. The high-frequency component of the surround back left audio signal SBL is removed by the LPF 22h, and the surround back left audio signal SBL is supplied to the volume adjuster 14 through the switch S27. The volume adjuster 14 adjusts the volume of the surround left audio signal SL, and supplies the surround left audio signal SL to the surround left speaker SSL through the surround left speaker terminal 15f. The volume adjuster 14 adjusts the volume of the surround back left audio signal SBL, and supplies the surround back left audio signal SBL to the surround back left speaker SSBL through the surround back left speaker terminal 15g.

The DAC 21e performs the digital-analog conversion of the input combination SR/SBR of the surround right audio signal SR and the surround back right audio signal SBR, which are input from the DSP, supplies the surround right audio signal SR to the LPF 22i, and supplies the surround back right audio signal SBR to the LPF 22j. The high-frequency component of the surround right audio signal SR is removed by the LPF 22i, and the surround right audio signal SR is supplied to the volume adjuster 14 through the switches S24 and S26. The high-frequency component of the surround back right audio signal SBR is removed by the LPF 22j, and the surround back right audio signal SBR is supplied to the volume adjuster 14. The volume adjuster 14 adjusts the volume of the surround right audio signal SR, and supplies the surround right audio signal SR to the surround right speaker SSR through the surround right speaker terminal 15h. The volume adjuster 14 adjusts the volume of the surround back right audio signal SBR, and supplies the surround back right audio signal SBR to the surround back right speaker SSBR through the surround back right speaker terminal 15i.

At this point, similarly to the first embodiment in FIG. 4, the audio signals of other channels may be output from the speaker terminals of the channels, and the audio signal of the specific channel may differentially be output.

(3) In the Case where the Differential Output is Performed

The description is made with reference to FIG. 10. The control unit 2 causes the DSP to supply the combination SR/SBR of the surround right audio signal SR and the surround back right audio signal SBR to the other end (the lower side) of the switch S21. The control unit 2 causes the switch S21 to supply the combination SR/SBR of the surround right audio signal SR and the surround back right audio signal SBR to the DAC 21e (that is, the switch S21 is switched to the lower side), the control unit 2 controls the switches S23 and S25 such that they are in the on state, and the control unit 2 controls the switches S2, S3, S22, and S24 such that they are in the off state. The control unit 2 switches the switch S26 to the upper side (the side of the switch S25), and switches the switch S27 to the lower side (the side of the LPF 22h).

The DAC 21d performs the digital-analog conversion of the input combination SL/SBL of the surround left audio signal SL and the surround back left audio signal SBL, which are input from the DSP, supplies the surround left audio signal SL to the LPF 22g, and supplies the inversion signal SL− of the surround left audio signal SL to the LPF 22h. The high-frequency component of the surround left audio signal SL is removed by the LPF 22g, and the surround left audio signal SL is supplied to the positive-side input terminal of the differential circuit 23d. The high-frequency component of the inversion signal SL− of the surround left audio signal SL is removed by the LPF 22h, and the inversion signal SL− of the surround left audio signal SL is supplied to the negative-side input terminal of the differential circuit 23d. The differential circuit 23d doubles the amplitude value of the surround left audio signal SL, and supplies the doubled surround left audio signal SL to the volume adjuster 14 through the switch S23. The volume adjuster 14 adjusts the volume of the surround left audio signal SL, and supplies the surround left audio signal SL to the surround left speaker SSL through the surround left speaker terminal 15f.

The DAC 21e performs the digital-analog conversion of the input combination SR/SBR of the surround right audio signal SR and the surround back right audio signal SBR, which are input from the DSP, supplies the surround right audio signal SR to the LPF 22i, and supplies the inversion signal SR− of the surround right audio signal SR to the LPF 22j. The high-frequency component of the surround right audio signal SR is removed by the LPF 22i, and the surround right audio signal SR is supplied to the positive-side input terminal of the differential circuit 23e. The high-frequency component of the inversion signal SR− of the surround right audio signal SR is removed by the LPF 22j, and the inversion signal SR− of the surround right audio signal SR is supplied to the negative-side input terminal of the differential circuit 23e. The differential circuit 23e doubles the amplitude value of the surround right audio signal SR, and supplies the doubled surround right audio signal SR to the volume adjuster 14 through the switches S25 and S26. The volume adjuster 14 adjusts the volume of the surround right audio signal SR, and supplies the surround right audio signal SR to the surround right speaker SSR through the surround right speaker terminal 15h.

At this point, similarly to the embodiment in FIG. 4, the audio signals of other channels may be output from the speaker terminals of the channels, and the audio signal of the specific channel may differentially be output.

As described above, in the second embodiment, the DAC that performs the digital-analog conversion of the combination ZL/ZR of the sub-room left audio signal ZL and the sub-room right audio signal ZR is also used as the DAC that performs the digital-analog conversion of the combination SR/SBR of the surround right audio signal SR and the surround back right audio signal SBR. It is not necessary to provide the DAC that performs the digital-analog conversion of the combination ZL/ZR of the sub-room left audio signal ZL and the sub-room right audio signal ZR. Therefore, the number of DACs can be decreased. In the case where the sub-room left audio signal ZL and the sub-room right audio signal ZR are played back, the audio signal supplied to the DAC 21 is changed from the combination SL/SBL of the surround left audio signal SL and the surround back left audio signal SBL in FIG. 10 to the combination SL/SR of the surround left audio signal SL and the surround right audio signal SR in FIG. 9. Accordingly, the audio signals can also be played back from the sub-room speakers disposed in the sub-room while the audio signals (the left audio signal L, the right audio signal R, the central audio signal C, the surround left audio signal SL, the surround right audio signal SR, and the low-frequency left audio signal SWL) of at least the basic 5.1 channels are played back from the main-room speakers disposed in the main room.

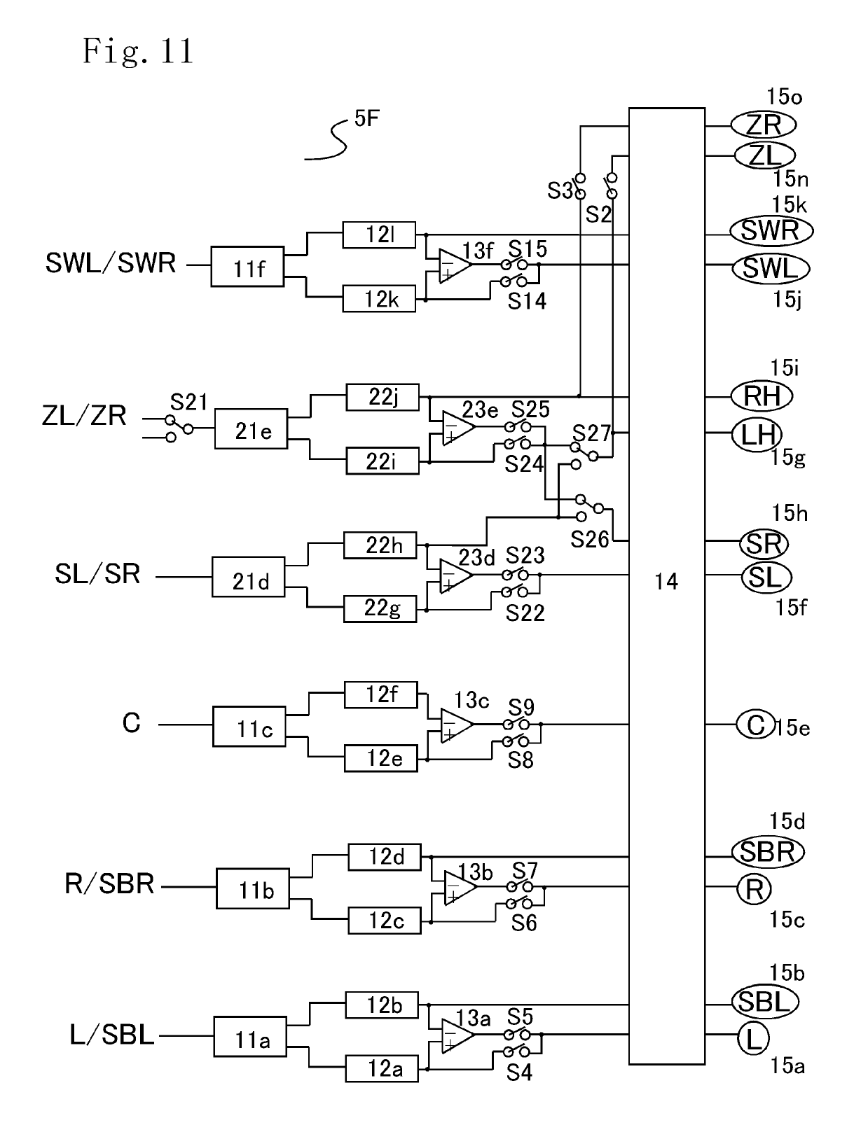

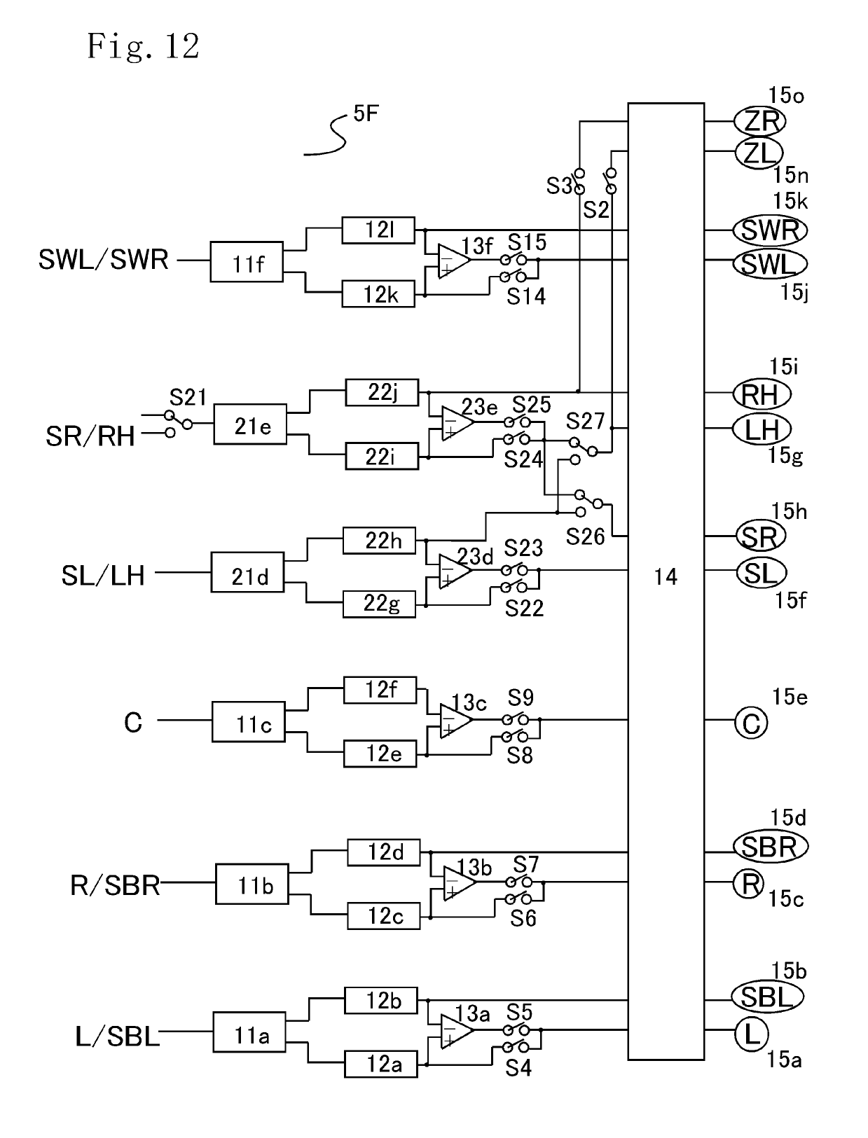

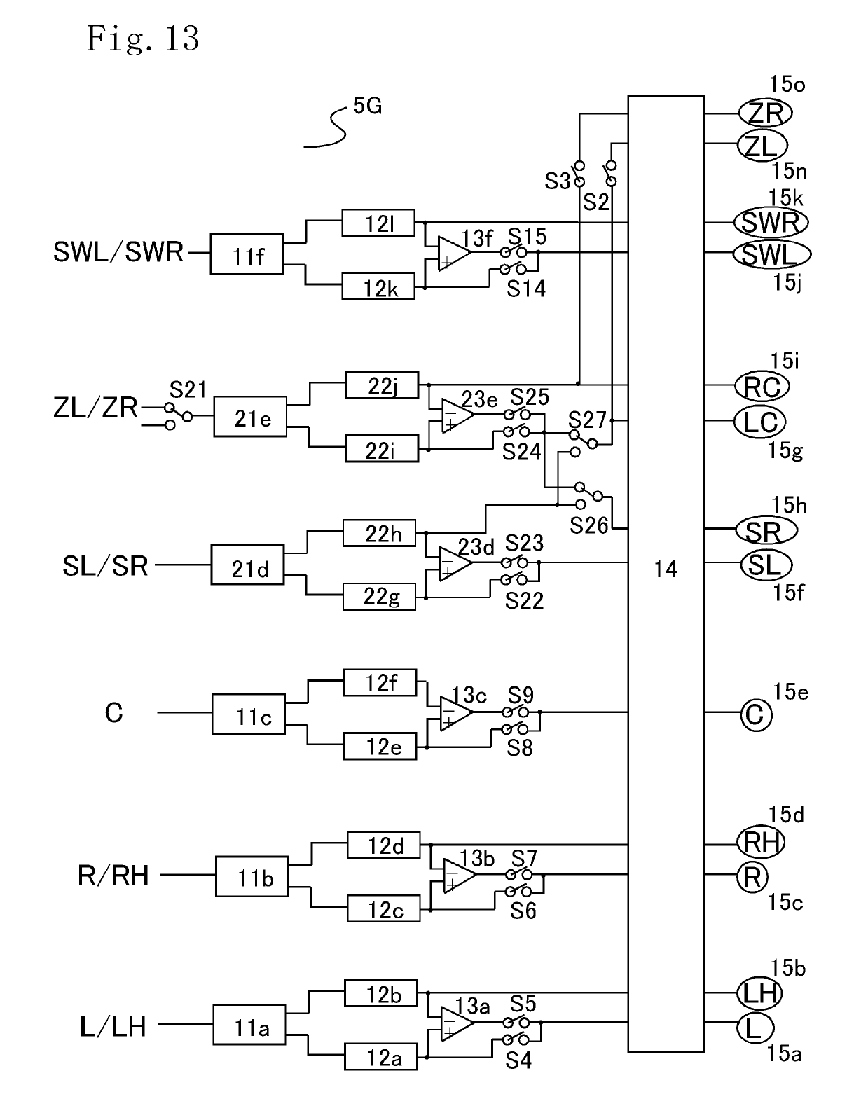

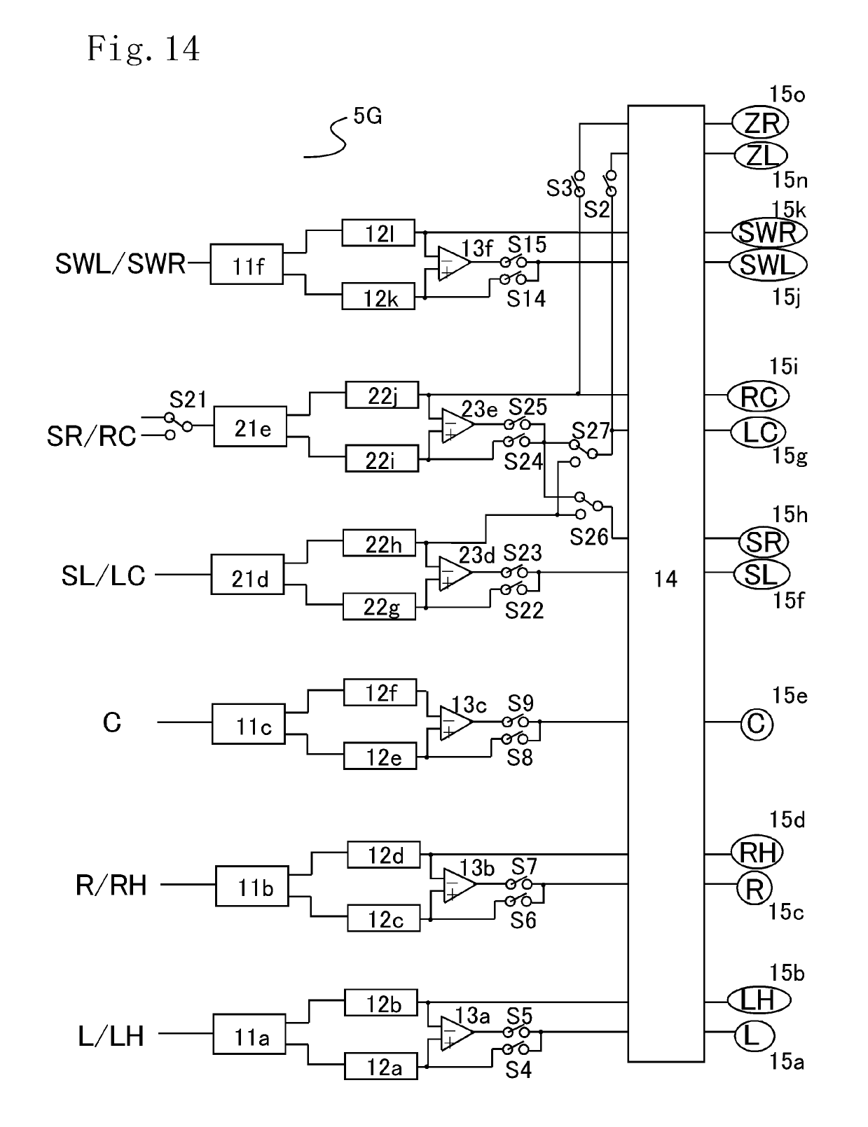

A configuration, in which the surround back left audio signal SBL and the upper left audio signal LH are replaced with each other while the surround back right audio signal SBR and the upper right audio signal RH are replaced with each other, may be used as illustrated in FIGS. 11 and 12. As illustrated in FIGS. 13 and 14, the center left audio signal LC may be used instead of the surround back left audio signal SBL, and the center right audio signal RC may be used instead of the surround back right audio signal SBR.

In view of the foregoing, when the channels of the second embodiment are generally expressed, the surround back left audio signal SBL is defined as an extended left audio signal and the surround back right audio signal SBR is defined as an extended right audio signal in FIGS. 9 and 10. The extended left audio signal may be any one of the outer left audio signal LW, the surround back left audio signal SBL, the upper left audio signal LH, and the center left audio signal LC. Similarly the extended right audio signal may be any one of the outer right audio signal RW, the surround back right audio signal SBR, the upper right audio signal RH, and the center right audio signal RC.

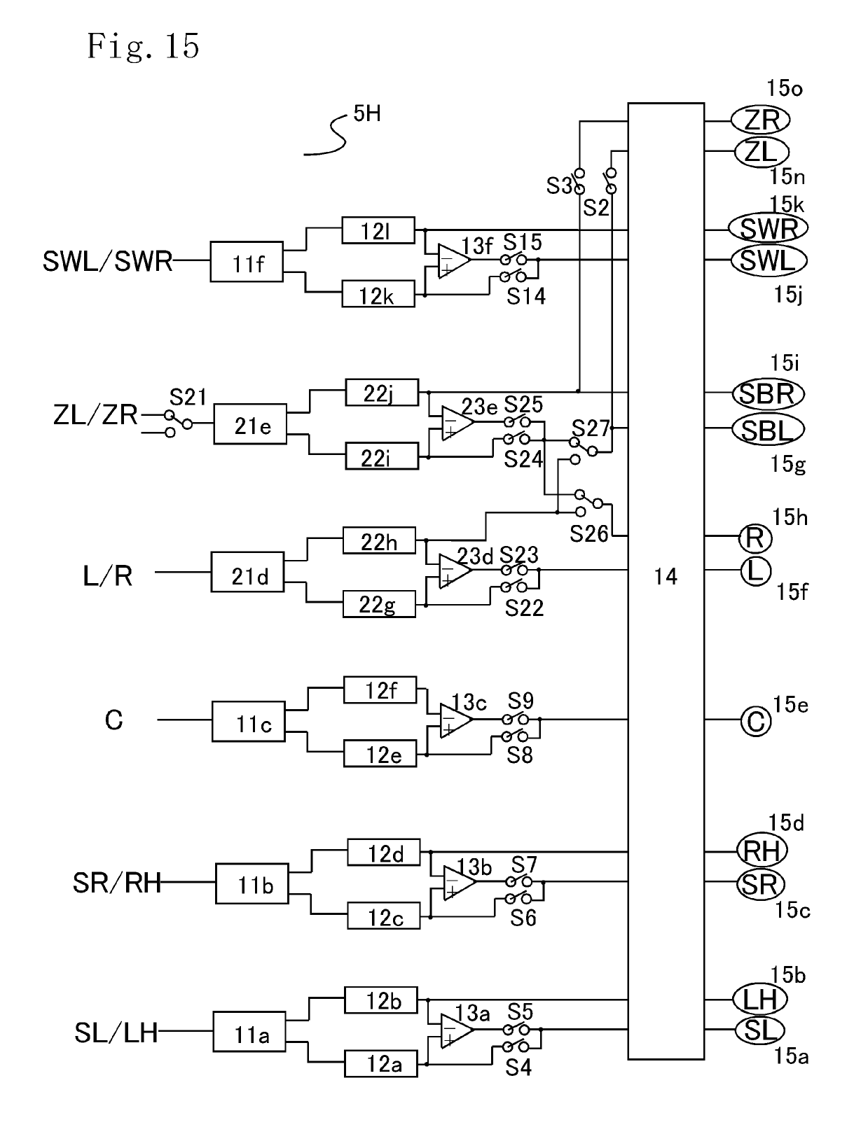

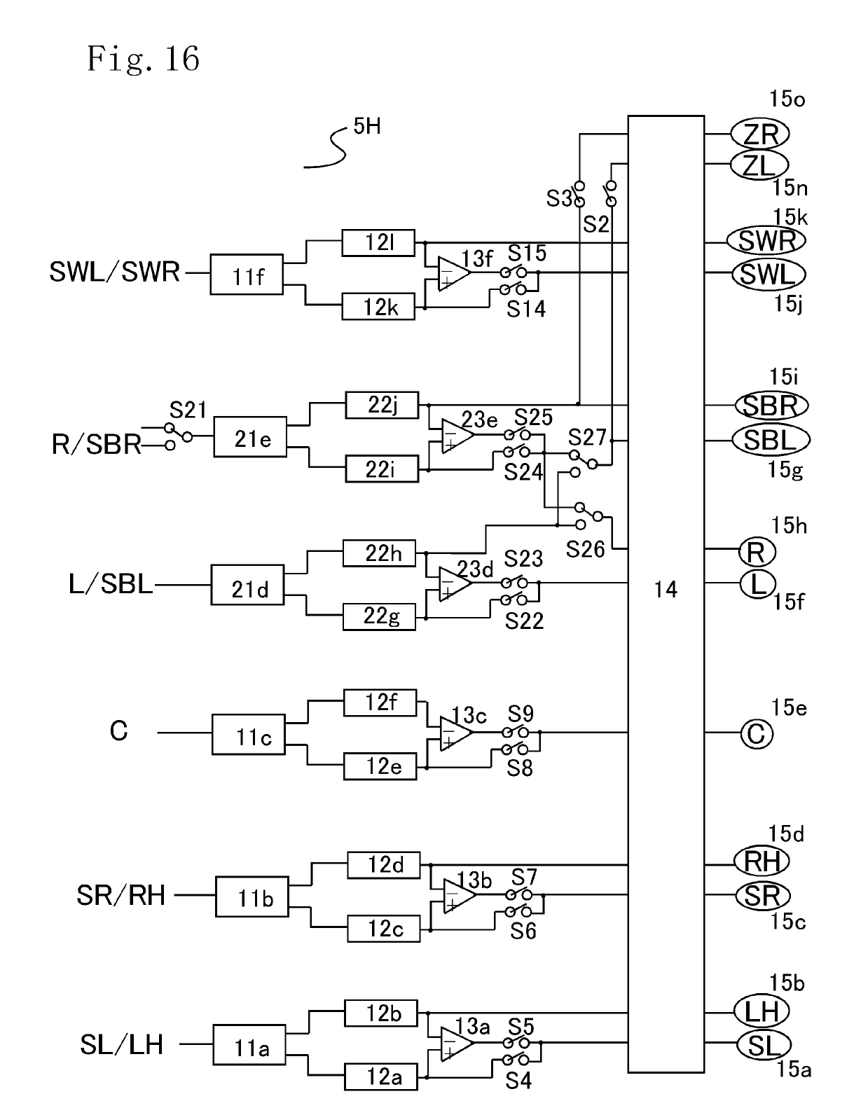

A configuration, in which the surround left audio signal SL and the left audio signal L are replaced with each other while the surround right audio signal SR and the right audio signal R are replaced with each other, may be used as illustrated in FIGS. 15 and 16. In view of the foregoing, when the channels of the second embodiment are generally expressed, the surround left audio signal SL is defined as a first left audio signal and the surround right audio signal SR is defined as a first right audio signal in FIGS. 9 and 10. The first left audio signal may be one of the left audio signal SL and the surround left audio signal SL. Similarly the first right audio signal may be one of the right audio signal SR and the surround right audio signal SR.

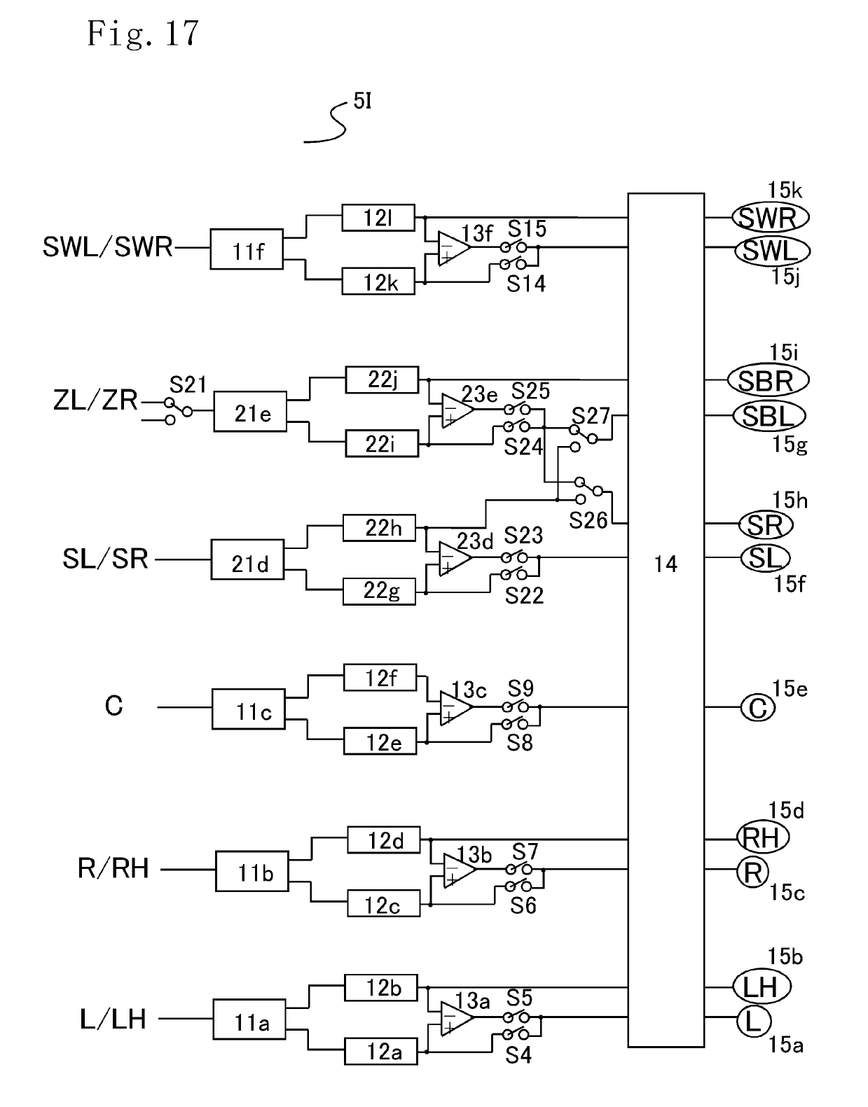

As illustrated in FIG. 17, the surround back left speaker terminal 15g may also be used as the sub-room left speaker terminal, and the surround back right speaker terminal 15i may also be used as the sub-room right speaker terminal. In this case, one of the surround back left speaker SSBL and the sub-room left speaker SZL can be connected to the surround back left speaker terminal 15g. Similarly one of the surround back right speaker SSBR and the sub-room right speaker SZR can be connected to the surround back right speaker terminal 15i. Compared with FIG. 9, the switches S2 and S3, the sub-room left speaker terminal 15n, and the sub-room right speaker terminal 15o are eliminated in FIG. 17.

Although the embodiments of the present invention are described above, the present invention is not limited to the embodiments. A program that causes a computer to execute the operation of the AV amplifier and a recording medium in which the program is recorded may be provided.

The present invention is suitably applied to the AV amplifier and the like.

What is claimed is:

1. An audio processing apparatus comprising:
a digital-analog conversion unit to which an extended left audio signal and an extended right audio signal in a digital format are input, the digital-analog conversion unit outputting the extended left audio signal and the extended right audio signal in an analog format, or a sub-room left audio signal and a sub-room right audio signal in the digital format being input to the digital-analog conversion unit, the digital-analog conversion unit outputting the sub-room left audio signal and the sub-room right audio signal in the analog format; and
an input switch unit that switches between a supply of a combination of the extended left audio signal and the extended right audio signal to the digital-analog conversion unit and a supply of a combination of the sub-room left audio signal and the sub-room right audio signal to the digital-analog conversion unit.

2. The audio processing apparatus according to claim 1 further comprising:
an extended left audio output terminal;
an extended right audio output terminal;
a sub-room left audio output terminal;
a sub-room right audio output terminal; and
an output switch unit that switches between both the supply of the extended left audio signal output from the digital-analog conversion unit to the extended left audio output terminal and the supply of the extended right audio signal output from the digital-analog conversion unit to the extended right audio output terminal and both the supply of the sub-room left audio signal output from the digital-analog conversion unit to the sub-room left audio output terminal and the supply of the sub-room right audio signal output from the digital-analog conversion unit to the sub-room right audio output terminal.

3. The audio processing apparatus according to claim 1, wherein the extended left audio signal is one of a surround back left audio signal, an outer left audio signal, an upper left audio signal, and a center left audio signal, and
the extended right audio signal is one of a surround back right audio signal, an outer right audio signal, an upper right audio signal, and a center right audio signal.

4. An audio processing apparatus comprising:
a first digital-analog conversion unit to which a first left audio signal and a first right audio signal in a digital format are input, the first digital-analog conversion unit outputting the first left audio signal and the first right audio signal in an analog format, or the first left audio signal and an extended left audio signal in the digital format being input to the first digital-analog conversion unit, the first digital-analog conversion unit outputting the first left audio signal and the extended left audio signal in the analog format;
a second digital-analog conversion unit to which a sub-room left audio signal and a sub-room right audio signal in the digital format are input, the second digital-analog conversion unit outputting the sub-room left audio signal and the sub-room right audio signal in the analog format, or the first right audio signal and an extended right audio signal in the digital format being input to the second digital-analog conversion unit, the second digital-analog conversion unit outputting the first right audio signal and the extended right audio signal in the analog format; and
an input switch unit that switches between both a supply of a combination of the first left audio signal and the first right audio signal to the first digital-analog conversion unit and a supply of a combination of the sub-room left audio signal and the sub-room right audio signal to the second digital-analog conversion unit and both a supply of a combination of the first left audio signal and the extended left audio signal to the first digital-analog conversion unit and a supply of a combination of the first right audio signal and the extended right audio signal to the second digital-analog conversion unit.

5. The audio processing apparatus according to claim 4, further comprising an output switch unit that switches between the supply of the first left audio signal output from the first digital-analog conversion unit, the supply of the first right audio signal output from the first digital-analog conversion unit, the supply of the sub-room left audio signal output from the second digital-analog conversion unit, and the supply of the sub-room right audio signal output from the second digital-analog conversion unit and the supply of the first left audio signal output from the first digital-analog conversion unit, the supply of the first right audio signal output from the second digital-analog conversion unit, the supply of the extended left audio signal output from the first digital-analog conversion unit, and the supply of the extended right audio signal output from the second digital-analog conversion unit.

6. The audio processing apparatus according to claim 5, further comprising:
a first left audio output terminal;
a first right audio output terminal;
an extended left audio output terminal;
an extended right audio output terminal;
a sub-room left audio output terminal; and
a sub-room right audio output terminal,
wherein the output switch unit switches between the supply of the first left audio signal output from the first digital-analog conversion unit to the first left audio output terminal, the supply of the first right audio signal output from the first digital-analog conversion unit to the first right audio output terminal, the supply of the sub-room left audio signal output from the second digital-analog conversion unit to the sub-room left audio output terminal, and the supply of the sub-room right audio signal output from the second digital-analog conversion unit to the sub-room right audio output terminal and the supply of the first left audio signal output from the first digital-analog conversion unit to the first left audio output terminal, the supply of the first right audio signal output from the second digital-analog conversion unit to the first right audio output terminal, the supply of the extended left audio signal output from the first digital-analog conversion unit to the extended left audio output terminal, and the supply of the extended right audio signal output from the second digital-analog conversion unit to the extended right audio output terminal.

7. The audio processing apparatus according to claim 6, further comprising:
a first differential circuit; and
a second differential circuit,
wherein the first digital-analog conversion unit outputs the first left audio signal and an inversion signal of the first left audio signal based on the input first left audio signal,
the second digital-analog conversion unit outputs the first right audio signal and an inversion signal of the first right audio signal based on the input first right audio signal,
the first left audio signal output from the first digital-analog conversion unit is input to a positive-side input of the first differential circuit, and the inversion signal of the first left audio signal output from the first digital-analog conversion unit is input to a negative-side input of the first differential circuit, whereby the first differential circuit outputs the first left audio signal while an amplitude of the first left audio signal is doubled,
the first right audio signal output from the second digital-analog conversion unit is input to the positive-side input of the second differential circuit, and the inversion signal of the first right audio signal output from the second digital-analog conversion unit is input to the negative-side input of the second differential circuit, whereby the second differential circuit outputs the first right audio signal while an amplitude of the first right audio signal is doubled, and
the output switch unit further switches between the supply of the first left audio signal output from the first differential circuit to the first left audio output terminal and the supply of the first right audio signal output from the second differential circuit to the first right audio output terminal.

8. The audio processing apparatus according to claim 4, wherein the extended left audio signal is one of a surround back left audio signal, an outer left audio signal, an upper left audio signal, and a center left audio signal, and
the extended right audio signal is one of a surround back right audio signal, an outer right audio signal, an upper right audio signal, and a center right audio signal.

9. The audio processing apparatus according to claim 4, wherein the first left audio signal is one of a left front audio signal and a surround left audio signal, and the first right audio signal is one of a right front audio signal and a surround right audio signal.
